(19) United States
(12) Patent Application Publication
(10) Pub. No.: US 2012/0110117 A1
(43) Pub. Date: May 3, 2012

(54) CONTENT RECEIVING APPARATUS

(76) Inventor: Hiroyuki KOREEDA, Fujisawa (JP)

(21) Appl. No.: 13/239,698

(22) Filed: Sep. 22, 2011

(30) Foreign Application Priority Data
Oct. 1, 2010 (JP) 2010-223382
Oct. 1, 2010 (JP) 2010-223383

(51) Int. Cl. G06F 15/16

(52) U.S. Cl. 709/217

(57) ABSTRACT

Content receiving apparatus including: a receiving unit which is an export medium having a content recording unit, and an export condition information recording unit; an export condition information acquisition unit having information indicating the number of times of export of content, and configured to acquire export condition information; and an export unit configured to export the content to the export medium in which the receiving unit receives specification, acquire the information on the number of times of export from the export condition information for the content, and in the case where the number of times of export of the acquired export information is two or more times, export the content to the recording medium, and set the export condition information of the content to the export condition information recording unit in the recording medium by using the number of times of export as much as multiple times.

### INCORPORATION BY REFERENCE

The present application claims priorities from Japanese applications JP2010-223382 filed on Oct. 1, 2010, JP2010-223383 filed on Oct. 1, 2010, the contents of which are hereby incorporated by reference into this application.

### BACKGROUND OF THE INVENTION

The present invention relates to a receiver for receiving content distributed from a distribution system via a network and a method of receiving the content, and to a method of distributing content in a content transmission and reception system configured by the distribution and the receiver.

As the background art of the technical field, in International Publication Pamphlet No. WO 2004-100549, there is disclosed an embodiment of realizing a distribution system including a server which distributes content and a receiver which downloads content from the server via the Internet and plays back it.

In this embodiment, there is shown an example in which the Internet browser acquires a download control file (in the present invention, referred to as a download control metafile) describing execution contents of content download from a server and a download agent interprets this file and executes the download.

### SUMMARY OF THE INVENTION

It is an object of the present invention to provide a content receiving apparatus capable of receiving and playing back digital rights-protected content distributed from various networks.

To solve the above-described problem, for example, a configuration described in the scope of claims is adopted.

According to an aspect of the invention, a content receiving apparatus includes a receiving unit which is an export medium having a content recording unit which records content and an export condition information recording unit which records export condition information of content, and configured to receive specification of an export medium which exports content; an export condition information acquisition unit having information on the number of times of export indicating the number of times of export of content to be exported to an export medium specified by the receiving unit, and configured to acquire export condition information in which export conditions of the content are described; and an export unit configured to export the content to the export medium in which the receiving unit receives specification, acquire the information on the number of times of export from the export condition information for the content, and in the case where the number of times of export of the acquired export information is two or more times, export the content to the recording medium, and set the export condition information of the content to the export condition information recording unit in the recording medium by using the number of times of export as much as multiple times.

According to the present invention, a content receiving apparatus can receive digital rights-protected content distributed from various networks and play back it while keeping attached use conditions, i.e. usage conditions.

Other objects, features and advantages of the invention will become apparent from the following description of the embodiments of the invention taken in conjunction with the accompanying drawings, i.e. usage conditions.

### BRIEF DESCRIPTION OF THE DRAWINGS

FIG. 1 illustrates a configuration example of a content transmission and reception system;

FIG. 2 illustrates a configuration example of a distribution system;

FIG. 3 illustrates a configuration example of a receiver;

FIG. 4 illustrates a first example of a relationship between a receiver and a distribution system;

FIG. 5 illustrates a second example of a relationship between a receiver and a distribution system;

FIG. 6 illustrates a third example of a relationship between a receiver and a distribution system;

FIG. 7 is a correlation diagram of ECG metadata;

FIG. 8 illustrates a configuration example of package metadata;

FIG. 9 illustrates a configuration example of download control information;

FIG. 10 illustrates a configuration example of a playback control metafile;

FIG. 11 illustrates a configuration example of a license;

FIG. 12 illustrates an example of a content retrieval screen of a receiver;

FIG. 13 illustrates an example of a retrieval result screen of a receiver;

FIG. 14 illustrates an example of a content purchase screen of a receiver;

FIG. 15 illustrates an example of a content detail display screen of a receiver;

FIG. 16 illustrates an example of a content playback screen of a receiver;

FIG. 17 illustrates an example of an export screen of a receiver;

FIG. 18 illustrates a transition example of web content presented on browser of a receiver;

FIG. 19 illustrates an example of a local navigation screen of a receiver;

FIG. 20 illustrates a configuration example of an interface portion between a receiver and a removable medium;

FIG. 21 illustrates a configuration example of an interface portion between a receiver and a network connection device;

FIG. 22 illustrates an example of a process flowchart in an ECG processing unit;

FIG. 23 illustrates an example of an export process flowchart to a removable medium in a stream export processing unit;

FIG. 24 illustrates an example of an export process flowchart to a network connection device in a stream export processing unit;

FIG. 25 illustrates an example of a process flowchart in a local navigation;

FIG. 26 illustrates another configuration example of an interface portion between a receiver and a removable medium;

FIG. 27 illustrates yet another configuration example of an interface portion between a receiver and a removable medium;

FIG. 28 illustrates a configuration example of license metadata;

FIG. 29 illustrates a configuration example of use condition information of an export license;

FIG. 30 illustrates an example of an export screen of a receiver;

FIG. 31 illustrates an example of an export method selection screen of a receiver;

FIG. 32 illustrates an example of an export execution result screen of a receiver;

FIG. 33 illustrates an example of an export screen of a receiver;

FIG. 34 illustrates an example of an export execution screen of a receiver;

FIG. 35 illustrates an example of an export execution result screen of a receiver; and

FIG. 36 illustrates an example of an export process flowchart to a removable medium in a stream export processing unit.

### DESCRIPTION OF THE EMBODIMENTS

Embodiments of the present invention will be described below.

### First Embodiment

In the present embodiment, an example of a receiver 50 which receives content and a distribution system 60 will be described.

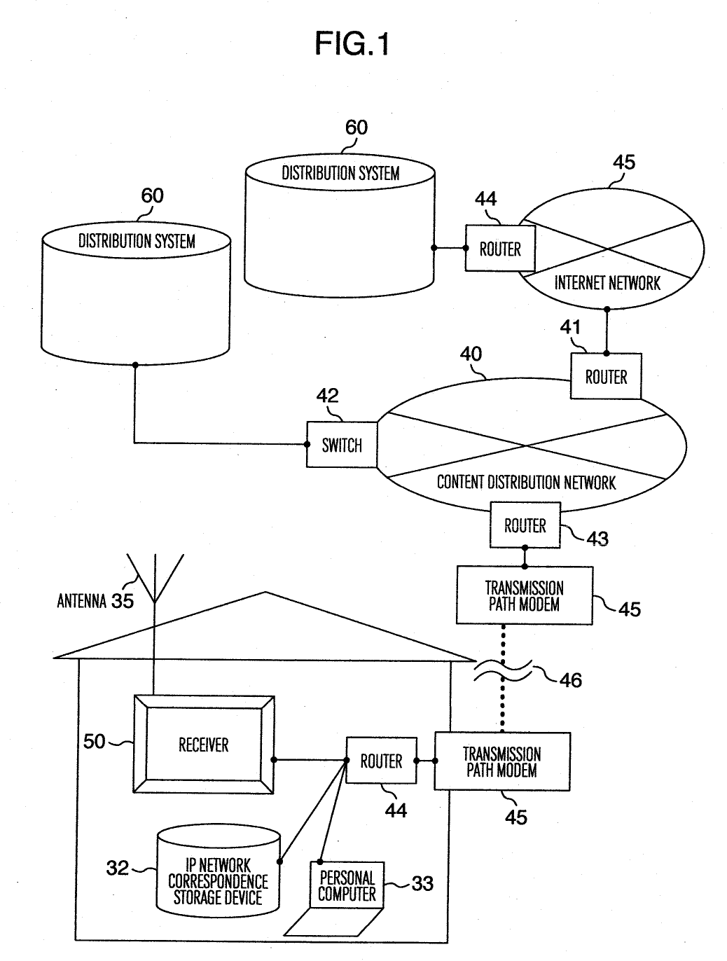

FIG. 1 illustrates a configuration example of a content transmission and reception system to which the present embodiment is applied. A distribution network is configured by a content distribution network 40 which is connected to a home via a rooter 43 and secures network quality in a network, and an external Internet network 45 connected from the content distribution network 40. A distribution system 60 may be connected to the content distribution network 40 via a network switch 42, or to the Internet network 45 via a rooter 44 with general versatility emphasized.

In a network connection to a home, various communication paths 46 such as a coaxial cable, an optical fiber, an asymmetric digital subscriber line (ADSL), and radio communication are supposed. Modulation or demodulation adapted to each path is performed by a transmission path MODEM unit 45, and converted into an IP network.

In the home, demodulation is performed by the transmission path MODEM unit 45, and the IP network converted into a network interface is connected to devices of the home via a rooter 44.

As the devices of the home, a receiver 50, a network attached storage 32 designed for the IP network, personal computer 33, and an audio-video equipment capable of being connected to a network are supposed. Possibly, the receiver 50 collectively has a function of playing back a broadcast program received by an antenna 35, and accumulating it.

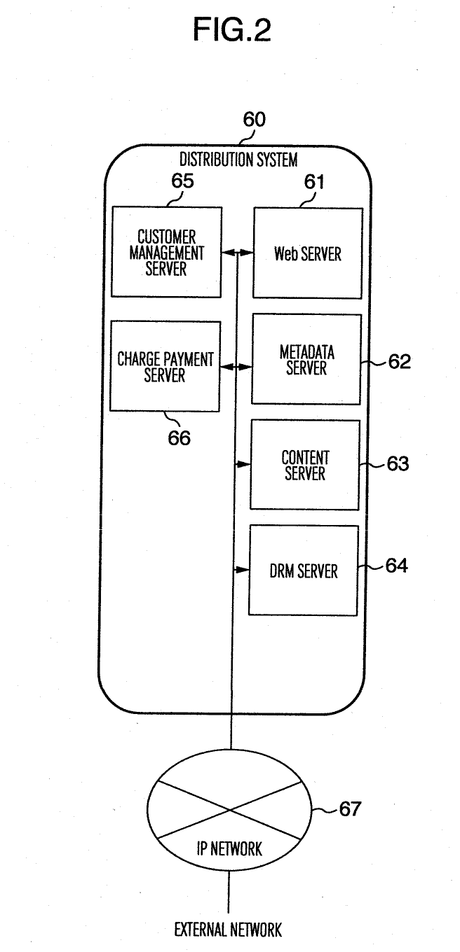

FIG. 2 illustrates a configuration example of the content distribution system 60.

The content distribution system 60 has a web server 61 which distributes a web document 71, ECG metadata 400 which describes attribute information on content to be distributed, a metadata server 62 which distributes playback control information 200 describing information necessary for playing back content, a content server 63 which distributes content itself 75, a DRM server 64 which distributes a license 300 including information on a key necessary for decoding of content necessary for a right to use or use of content, a customer management server 65 which manages customer information of a distribution service, and a charge payment server 66 which performs charging or settlement processing of content through a customer.

Each server is connected to each other via an IP network 67 as well as to Internet network 45 or content distribution network 40 of FIG. 1 via the IP network 67.

Note that a part or all of the servers may be connected directly to the Internet network 45 or the content distribution network 40 without the IP network 67, and they may communicate with each other.

Each server of the distribution system 60 is adamantly an opportunistic model.

In a real distribution system, the distribution system 60 may have a server resulting from integrating multiple types of servers in reality, or eliminate some servers. Further, the distribution system 60 may have a configuration in which a server used for distributing multiple data as in the metadata server 62 is divided and configured in reality according to category of data. Each server is connected via a network such as the Internet.

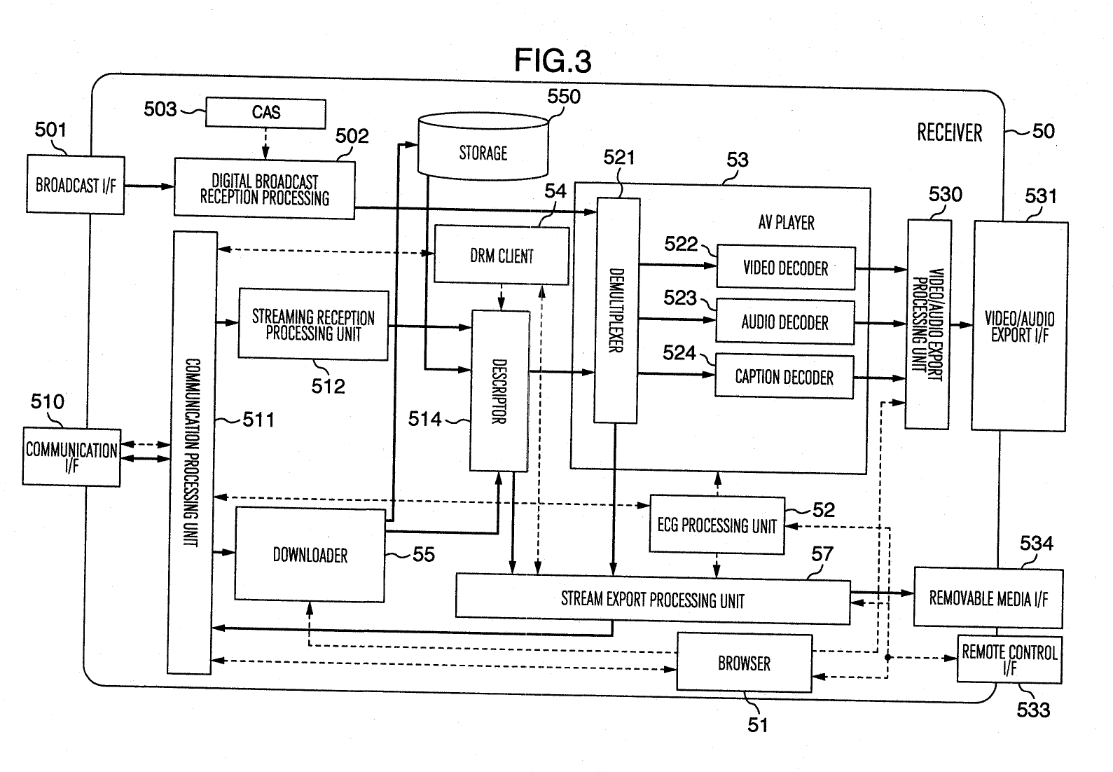

FIG. 3 illustrates a configuration example of the receiver 50.

The receiver 50 can play back received content and export it to a removable medium or network, and further has a storage 550 capable of accumulating content. In the figure, a solid line arrow represents a flow of content, and a dash line arrow represents a flow of control.

The receiver 50 is physically connected to the IP network. Further, the receiver 50 has a communication interface (I/F) 510 which transmits and receives Internet protocol (IP) data packet, and via the communication I/F 510, a communication processing unit 511 which performs processing of various IP communication protocols such as a transmission control protocol (TCP), user datagram protocol (UDP), dynamic host configuration protocol (DHCP), domain name server (DNS), and hyper text transfer protocol (HTTP).

A downloader 55 is a processing unit which performs processing for acquiring content or information related to content. A DRM client 54 manages digital rights of content, and provides a function of viewing content or controlling copies according to purchase conditions of content. A descriptor 514 decodes content to be downloaded based on an instruction from the DRM client 54. A stream export processing unit 57 exports content to a removable medium 560 connected to the receiver 50. In addition, the stream export processing unit 57 exports content to a network connection device 570 connected via the communication processing unit 511 and the communication I/F 510.

The removable medium 560 is an accessible and detachable storage medium via the removable medium I/F 534 connected to the stream export processing unit 57.

The receiver 50 has a remote controller I/F 533 for operation, and is operated by a user in accordance with a remote control signal received thereby.

In addition, there is the possibility that the receiver 50 includes a function of receiving a streaming distribution service of on-demand video and audio content. In this case, the receiver 50 has a streaming reception processing unit 512 which processes real-time reception of the video and audio content via the communication processing unit 511.

An AV player 53 decodes downloaded content, content distributed by steaming distribution, or content in which a broadcast is received, and converts the decoded content into video and audio signals.

The AV player 53 internally has a demultiplexer 521. The processing unit separates content decoded by the descriptor 514 into video, audio, and caption packets, and supplies each packet to a video decoder 522, an audio decoder 523, and a caption decoder 524. By the above-described decoders 522, 523, and 524, information on the video, audio, and caption is decoded, respectively, and converted into integrated video and audio signals by a video and audio export processing unit 530. The video and audio signals are externally exported from the receiver 50 via a video and audio export I/F 531.

Therefore, when a TV set is connected to the video and audio export I/F 531, a user can view content including video and audio.

The video and audio export processing unit 530 and the video and audio export I/F 531 are also considered to be an interface of HDMI (trademark) specifications to integrate, process, and export the video and audio. Further, there is also assumed an example of a video composite signal export and analog audio export as exported externally by independently processing the video and audio.

Further, the receiver 50 may simultaneously has functions of receiving and recording digital broadcast programs. In that case, the receiver 50 has a broadcast I/F 501 which inputs airwaves, a digital broadcast reception processing unit 502 which decodes a digital broadcast signal and converts the decoded signal into a video/audio stream, and a conditional access system (CAS) 503 which performs digital rights protection processing at the time of decoding digital broadcast signals.

The receiver 50 can export the downloaded content directly to the stream export processing unit 57, and to the removable medium 560.

Further, the receiver 50 can store the downloaded content in the storage 550 once. In this case, the stream export processing unit 57 then exports the content acquired from the storage 550 to the removable medium 560 by using an operation of the receiver 50.

Even in a configuration having the storage 550, the receiver 50 may perform either of one process in which content is not stored in the storage 550 but exported, and another process in which content is once stored in the storage 550 and exported.

In this case, even when the receiver 50 has the storage 550 such as an HDD, the downloaded content can be exported to the removable medium 560 via the stream export processing unit 57. Therefore, the content is not required to be stored in the storage 550, and even when spacing is small in the recording capacity of the storage, the download can be performed.

Further, in the receiver 50 of FIG. 3, when only a service in which the content is exported directly to the removable medium 560 is performed without going through the storage 550, more inexpensive receiver on which the storage 550 is not mounted can be realized.

The downloaded content is not decoded and once stored in the storage 550 as it is. When the content stored in the storage 550 is played back or exported to the removable medium 560, the DRM client 54 acquires the license 300 from the DRM server 64. Based on a content key 311 described in the license 300, the descriptor 514 can also decode the content stored in the storage 550.

In the case of playing back the content, the descriptor 514 decodes the content and the demultiplexer 521 separates the content into a video, audio, and caption data packets. The video decoder 522, audio decoder 523, and caption decoder 524 decode the respective separated video, audio, and caption data packets. The video/audio export processing unit 530 exports the decoded video and audio to the outside via the video/audio export I/F 531. Through the above processing, a user can view the content.

In the case of exporting the content, the descriptor 514 decodes the content and the stream export processing unit 57 exports the decoded content to the removable medium 560.

All or part of the digital-broadcasting receiving processing unit 502, CAS 503, communication processing unit 511, streaming reception processing unit 512, descriptor 514, demultiplexer 521, video decoder 522, audio decoder 523, caption decoder 524, video/audio export processing unit 530, storage 550, browser 51, ECG processing unit 52, AV player 53, DRM client 54, downloader 55, local navigation 56, and stream export processing unit 57 illustrated in FIG. 3 are converted into an integrated circuit as a processing unit performing each processing to thereby be realized by using hardware.

Further, the digital-broadcasting receiving processing program 502, CAS program 503, communication processing program 511, streaming reception processing program 512, descriptor program 514, demultiplexer program 521, video decoder program 522, audio decoder program 523, caption decoder program 524, video/audio export processing program 530, storage 550, browser program 51, ECG processing program 52, AV player program 53, DRM client program 54, downloader program 55, local navigation program 56, and stream export processing program 57 stored in a storage device such as the storage 550 and memories (not illustrated) are processed by using an arithmetic processor of a central control unit (not illustrated). Through the above processing, each processing of all or part of the above-described programs can also be realized by using software.

For ease of explanation, each processing realized by performing various programs through the central control unit is described by using as a subject each processing unit realized by programs. When realizing each processing unit by using hardware, each processing unit performs each processing as a subject.

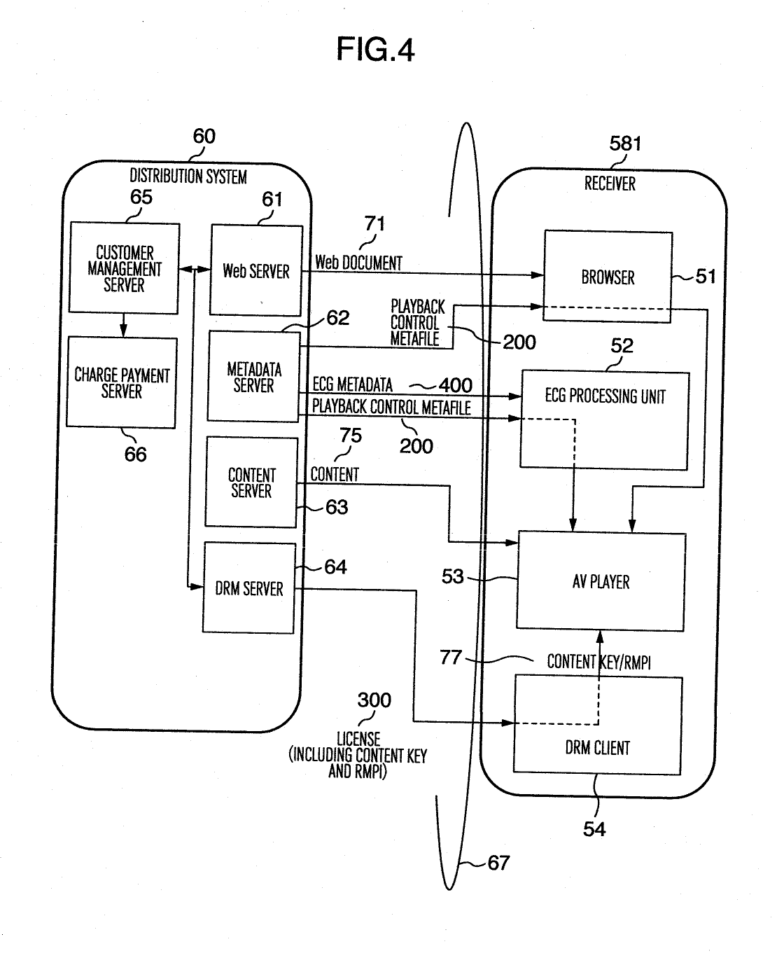

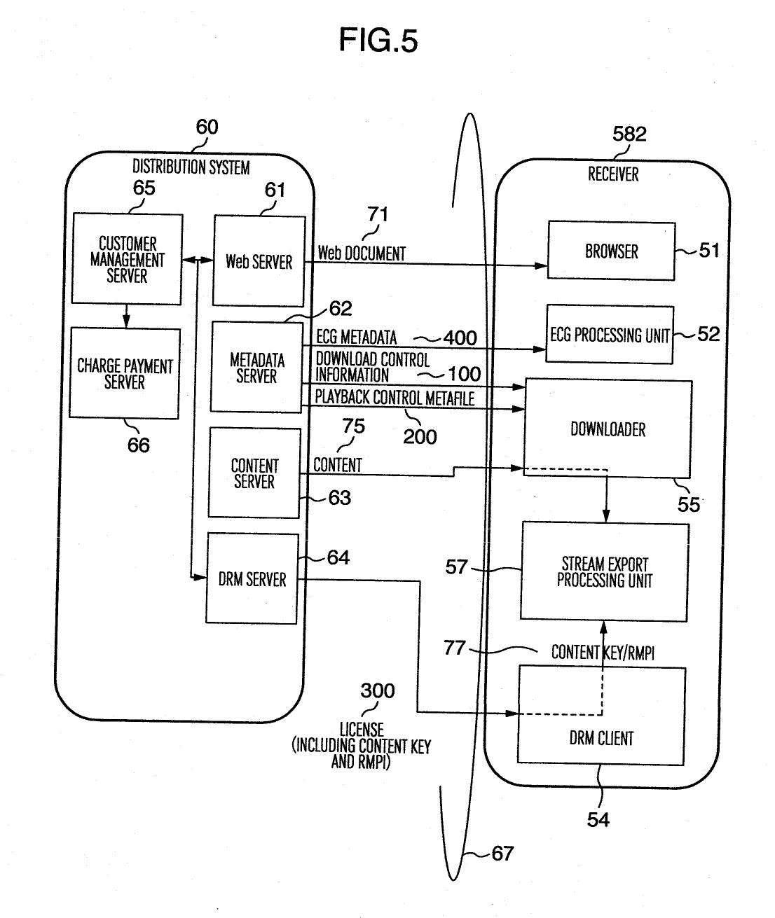

Next, a receiving/delivering relation on data of a content distribution service between the receiver 50 having a system configuration of FIG. 3 and the distribution system 60 of content of FIG. 2 will be described with reference to FIGS. 4, 5, and 6. In FIGS. 4 and 5, only part of blocks used in a flow of a process are displayed from the receiver 50 of FIG. 3. Other processing units of the receiver 50 of FIG. 3 may be included, respectively, and further a configuration illustrated in FIGS. 4 and 5 is not necessarily used. Part of the configuration may be omitted.

A receiver 581 of FIG. 4 is a subset resulting from extracting a block for giving and receiving data to and from a streaming distribution system from the receiver 50 of FIG. 3.

The content distribution system 60 includes the web server 61 which distributes the web document 71, the ECG metadata 400 which describes attribute information on content to be distributed, the metadata server 62 which distributes the playback control metafile 200 describing information necessary for playing back content, the content server 63 which distributes content itself 75, the DRM server 64 which distributes the license 300 including information on a key necessary for decoding content necessary for a right to use of content or use of content, the customer management server 65 which manages customer information of a distribution service, and the charge payment server 63 which performs charging or settlement processing of content through a customer.

For a transmission path 67 in which the above data is communicated between the receiver 581 and the distribution system 60, the distribution network of FIG. 1 is assumed.

In the case of FIG. 4, the browser 51 presents the Web document 71 received from the Web server 61, and retrieves the content 75 desired to be viewed by a user to be found out by operating an operation device such as a remote control. In addition, as another method, there may be provided a method in which the electric content guide (ECG) processing unit 52 of receiver application presents the ECG metadata 400 acquired from the metadata server 62 to a user in a format of ECG, and the user retrieves and finds out the content 75 desired to be viewed from the ECG.

When a user selects content desired to be viewed and makes a playback instruction of content on the web document 71, the browser 51 acquires from the metadata server 62 the playback control metafile 200 in which a reference destination is described in the web document 71 and requests playback to the AV player 53. Alternatively, when the user makes a playback instruction of content on the ECG displayed by the ECG processing unit 52, the ECG processing unit 52 acquires from the metadata server 62 the playback control metafile 200 in which a reference destination is described in the ECG metadata 400 and requests playback to the AV player 53.

According to contents of the playback control metafile 200, the AV player 53 acquires, from the DRM client 54, signal export limitation and copy control information called a content key and right management and protection information (RMPI) described in the license 300 of the content. Further, the AV player 53 sets the content key in the descriptor 514 and sets export conditions such as video and audio in the video/audio export I/F 531 according to the RMPI, and performs streaming playback of the content 75 distributed from the content server 63.

The DRM client 54 holds the effective license 300, and when requested from the AV player 53 and the stream export processing unit 57, the DRM client 54 provides the content key and the RMPI from the corresponding license 300. Further, when the requested license 300 is not yet acquired, the DRM client 54 acquires the license 300 necessary for playing back content from the DRM server 64.

A receiver 582 of FIG. 5 is a subset resulting from extracting a block for giving and receiving data to and from a download distribution system from the receiver 50 of FIG. 3.

Also in the case of FIG. 5, the browser 51 presents the web document 71 received from the web server 61, and retrieves the content 75 desired to be viewed by a user to be found out by operating an operation device such as a remote control. In addition, as another method, there may be provided a method in which the ECG processing unit 52 of receiver application presents the ECG metadata 400 acquired from the metadata server 62 to a user in a format of ECG, and the user retrieves and finds out the content 75 desired to be viewed from the ECG.

When a user selects content desired to be viewed and makes a download instruction of content on the web document 71, the browser 51 acquires from the metadata server 62 download control information 100 in which a reference destination is described in the web document 71 and makes an execution request of download to the downloader 55. Alternatively, when the user makes a download instruction of content on the ECG displayed by the ECG processing unit 52, the ECG processing unit 52 acquires from the metadata server 62 the download control information 100 in which a reference destination is described in the ECG metadata 400 and makes an execution request of download to the downloader 55.

The downloader 55 acquires the playback control metafile 200. According to contents of the playback control metafile 200, from the DRM client 54, the downloader 55 acquires signal export limitation and copy control information called a content key and right management and protection information (RMPI) described in the license 300 of the content. Further, the downloader 55 sets the content key in the descriptor 514 and sets export conditions such as video and audio in the removable medium 560 and network connection device 570 as an export destination according to the RMPI. The downloader 55 downloads the content 75 distributed from the content server 63 and exports content decoded by the descriptor 514 to the stream export processing unit 57 to thereby perform export processing.

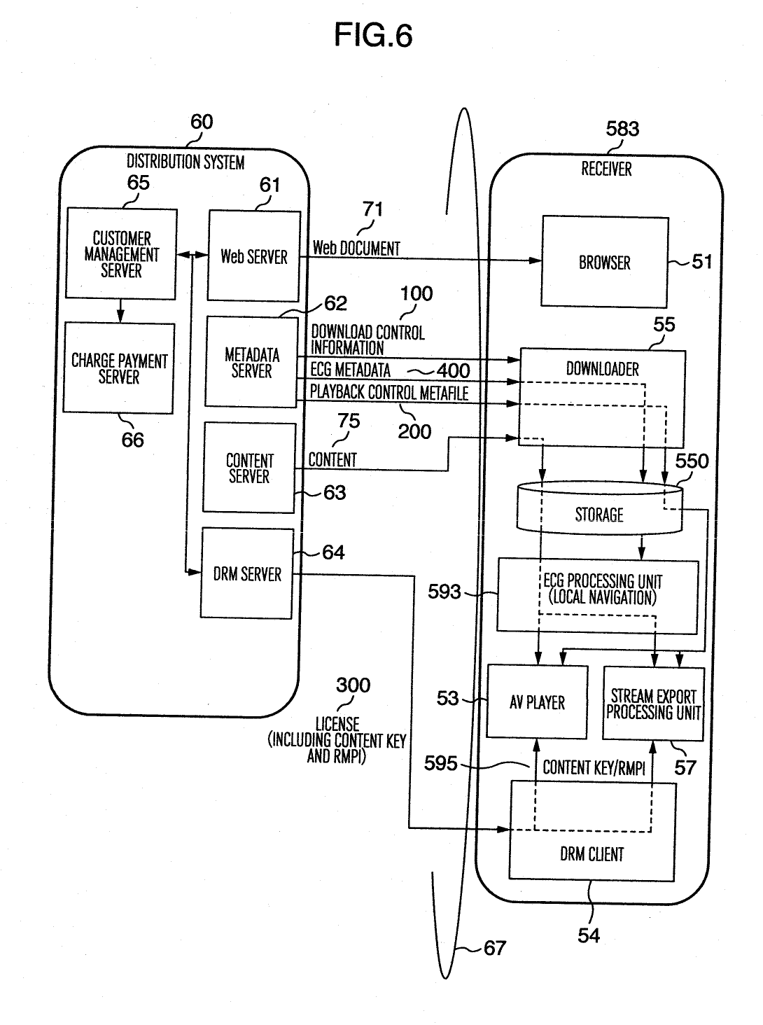

As a receiver 583 of FIG. 6, a block for giving and receiving data to and from a download distribution system via the storage 550 is extracted and described from the receiver 50 of FIG. 3.

In the case of FIG. 6, the browser 51 presents the web document 71 received from the web server 61, and retrieves and finds out the content 75 desired to be viewed by a user by operating an operation device such as a remote control. In the same manner as in FIG. 5, although omitted in the figure, the ECG processing unit 52 of receiver application may present the ECG metadata 400 acquired from the metadata server 62 to the user, and provide a method for retrieving and finding out the content 75 desired to be viewed by the user.

When a user selects content desired to be viewed and makes a download instruction of content on the web document 71, the browser 51 acquires from the metadata server 62 the download control information 100 in which a reference destination is described in the web document 71 and makes an execution request of download to the downloader 55.

The downloader 55 acquires the ECG metadata 400, playback control metafile 200, and content 75 of content to be downloaded, and accumulates them in the storage 550.

The accumulated content 75 can be retrieved, selected, played back, and exported by using application such as the local navigation 56 of the receiver.

When playback of the content is instructed by using the local navigation 56, the AV player 53 is started and the playback is requested. When the export of the content is instructed, the stream export processing unit 57 is started and the export processing is requested.

Next, contents of information to be processed by the receiver will be described in detail.

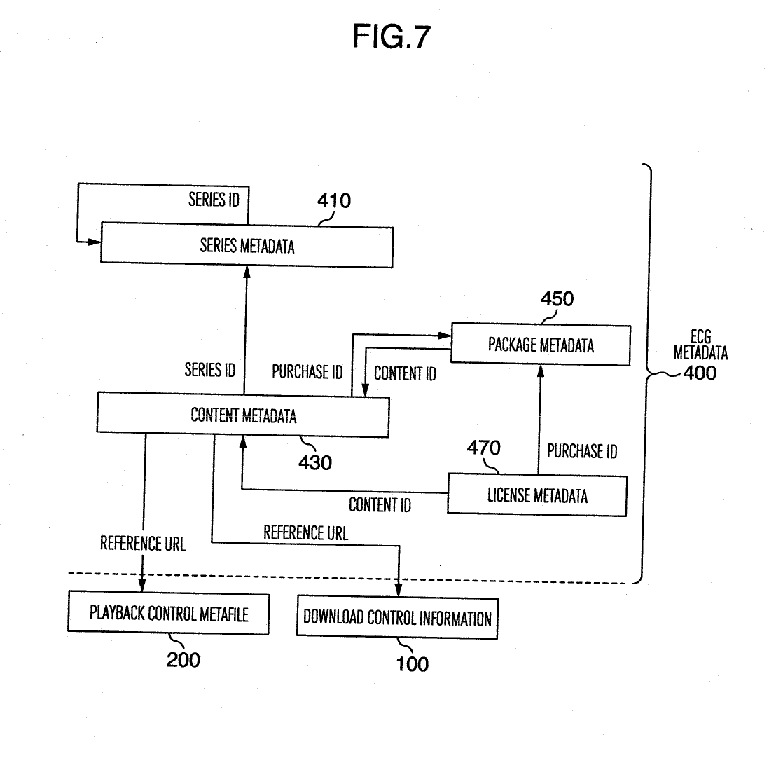

FIG. 7 is a correlation diagram of the ECG metadata 400 presented as the ECG for content retrieval by the ECG processing unit 52. The ECG metadata 400 is described in a format of XML.

The ECG metadata 400 is configured by content metadata 430 in which attribute information such as a name and description of separate distributed programs, video, audio, and genre is described, a series of metadata 410 in which a series of separate programs is grouped and managed to be retrieved, license metadata 470 in which purchased licenses of programs are described, and package metadata 450 in which purchase conditions of programs or grouped programs are described. In the content metadata 430, there can be described a group ID for uniquely discriminating the group metadata 410 to which its program belongs. In the group metadata 410, a hierarchical group configuration can be defined by describing the group ID of the group metadata 410 to which the program itself belongs.

The license metadata 470 has a content ID for uniquely discriminating the content metadata 430 of programs available by its license and a purchase ID for uniquely discriminating the package metadata 450 available as purchase conditions. The content metadata 430 and the package metadata 450 have the purchase ID and content ID corresponding to each other. The content metadata 430 can have reference information for acquiring the playback control information 200 for streaming-playing back content and the download control information 100 for downloading content when the content can be streaming-played back, downloaded, or streaming-played back and downloaded.

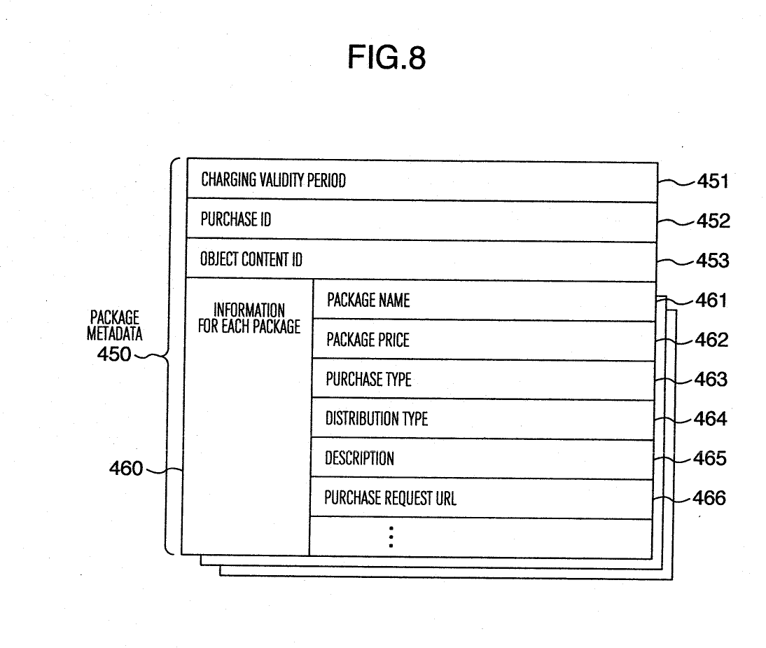

FIG. 8 illustrates a configuration example of the package metadata 450 in the ECG metadata 400.

The package metadata 450 holds a charging valid period 451 describing a start date and time and an end date and time of charging, a purchase ID 452 for uniquely discriminating the package metadata 450, and an object content ID 453 for discriminating content to be purchased of the package metadata 450.

Multiple packages can be described in one package metadata, and the package metadata 450 has the following information about respective packages.

A package name 461, package price 462, and description 465 are information for presenting package contents to a user. A purchase type 463 is information for discriminating a purchase form of a package such as a purchase in a single content type, a purchase of the entire series, or a purchase in monthly contract. A distribution type 464 is information for discriminating a distribution form in a content distribution, such as a streaming distribution, download distribution, or both of them.

A purchase request URL 466 is information describing an access destination of a server for requesting a purchase transaction based on a purchase operation of the user.

That is, the ECG processing unit 52 presents a retrieval screen with reference to the content metadata 430 or group metadata 410. When a user finds out content desired to be used, the ECG processing unit 52 presents purchase conditions of the content to the user with reference to the license metadata 470 of the content and allows the user to perform a purchase operation according to the package metadata 450. In the case where the streaming playback of the content is instructed on the ECG presented by the ECG processing unit 52, the ECG processing unit 52 acquires the playback control information 200 according to URL described in the content metadata 430 and the AV player 53 performs streaming playback according to the description content of the playback control information 200.

In the case where download of the content is instructed on the ECG presented by the ECG processing unit 52, the ECG processing unit 52 acquires the download control information 100 according to URL described in the content metadata 430 and the downloader 55 downloads the content according to the description content of the download control information 100.

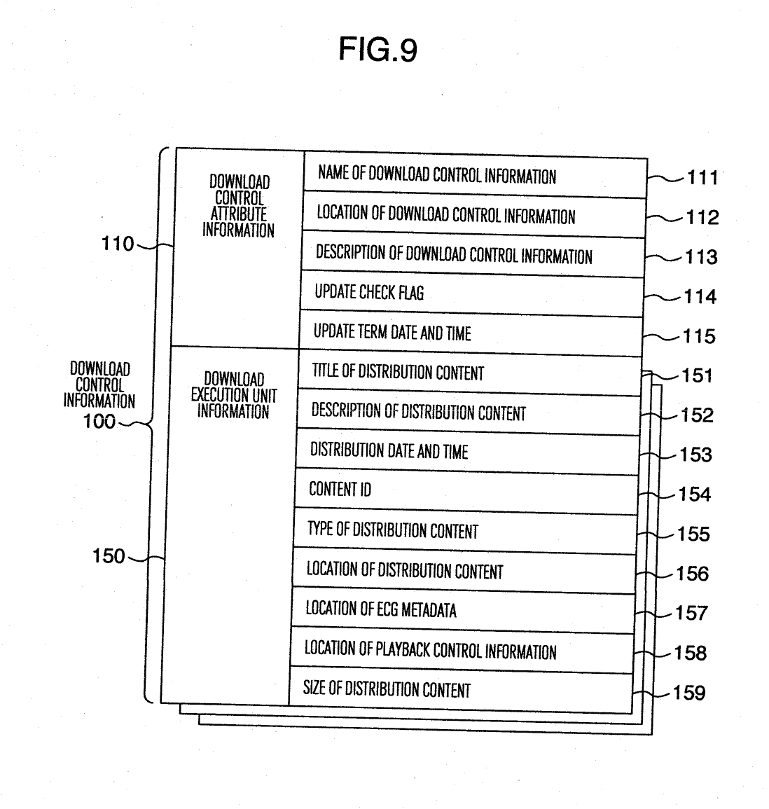

FIG. 9 illustrates a configuration example of the download control information 100. The download control information 100 includes download control attribute information 110 describing contents of a metafile itself and download execution unit data 150 used for downloading one or multiple content.

The download control information 100 is described, for example, in an RDF site summary or really simple syndication (RSS). The download control information can be created (prepared) to arbitrary multiple content within a certain package; however, it fails to be created to multiple packages.

Further, multiple download control information can be prepared to a certain package. Note that the download control information should be prepared so that all content within a package can be necessarily downloaded. The download control information 100 may be updated, and the receiver checks the download control information 100 at a constant frequency and updates a difference. In the case of the RSS, the receiver uniquely discriminates each content by using an enclosure url.

The download control information 100 has information such as a name 111 of download control information representing a name (e.g., a name, file name, and ID of a download reservation) of the corresponding download control information 100, a location 112 of download control information representing a location (For example, it may be a URL on the Internet of a website providing a download reservation. Note that it is not limited to a URL, but may be other addresses. Much the same is true on the locations.) of the corresponding download control information 100, a description 113 of download control information representing a description (e.g., a description and language type about a download reservation) of the corresponding download control information 100, an update check flag 114, and an updated term time and day 115.

The update check flag 114 is a flag which determines whether contents of the download control information 100 on the metadata server 62 is changed, and periodically checked. The update check flag 114 has both of an “updating” value for checking the content and a “single” value failing to periodically check the contents after a first acquisition. The update term date and time 115 is available in the case where the update check flag 114 has an “updating” value, and describes the term date and time for continuing to check an updating of the download control information 100.

The update term date and time 115 indicates the term for monitoring the updating of content. A unit (in units of day, hour, or minute) of the term is arbitrary. The update term date and time 115 can take a value indicating “no term”, namely, a value indicating that the check is semipermanently continued. In addition, as another execution method, when a special value (e.g., all values are zero) of the update term date and time 115 is treated as a “single” value of the update check flag 114, a configuration in which the update check flag 114 is omitted can also be realized.

The multiple download execution unit data 150 can be described in the download control information 100. With regard to each content to be downloaded, the multiple download execution unit data 150 stores information such as a title 151 of distribution content representing a title (may be a program name, or a file name and ID) of the content, a description 152 of the distribution content representing a description (features and remarks) of the content, a distribution date and time 153 representing date and time (may be a unit of day or minute) for distributing the content, a content ID 154 of the distribution content for uniquely discriminating the content on the Internet, a type 155 of the distribution content, a location 156 of the content indicating an acquisition destination URL of the distribution content, a location 157 of an ECG metadata indicating the acquisition destination URL of the ECG metadata corresponding to the content, a location 158 of the playback control information indicating the acquisition destination URL of the playback control information corresponding to the content, and a size 159 of the distribution content.

As one example, the content ID identifier 154 is described by using a character string regulated by a schema referred to as “CRID://authority/content_id”. A portion of authority is a keyword for uniquely discriminating a distributor of the content on the network. In the present embodiment, a domain name managed as a unique name on the Internet is operated as authority.

Here, content_id after authority/ is an ID for uniquely discriminating content within the authority, and a format of the character string may be freely operated by using the authority. Through the above operation, the content on the Internet can be uniquely discriminated by using the content identifier 154. When accessing the content identifier 154 as a URL on the Internet, a user can acquire content as an object and related metadata.

As the distribution date and time 153, there is described a date and time at which the content is normally stored in the content server 63 and disclosed. However, when the download control information 100 is distributed, the content is not yet disclosed and a future date and time to be distributed may be described in the distribution date and time 153. Further, when the distributed content is updated once, the updated date and time is described in the distribution date and time 153.

In the type 155 of the distribution content describes, for example, types of a video, photo, music, program, and multimedia data distributed from a server are described. The video may be further subdivided into a movie, news, and sport, and types of them may be described therein. The music may be further subdivided into a classic, rock, and jazz, and types of them may be described therein.

Metadata for distribution content is attached information necessary for playing back or executing content. As one example, the above-described metadata includes a genre for retrieving content and keyword information. When content is video information, the above includes its thumbnail and chapter information.

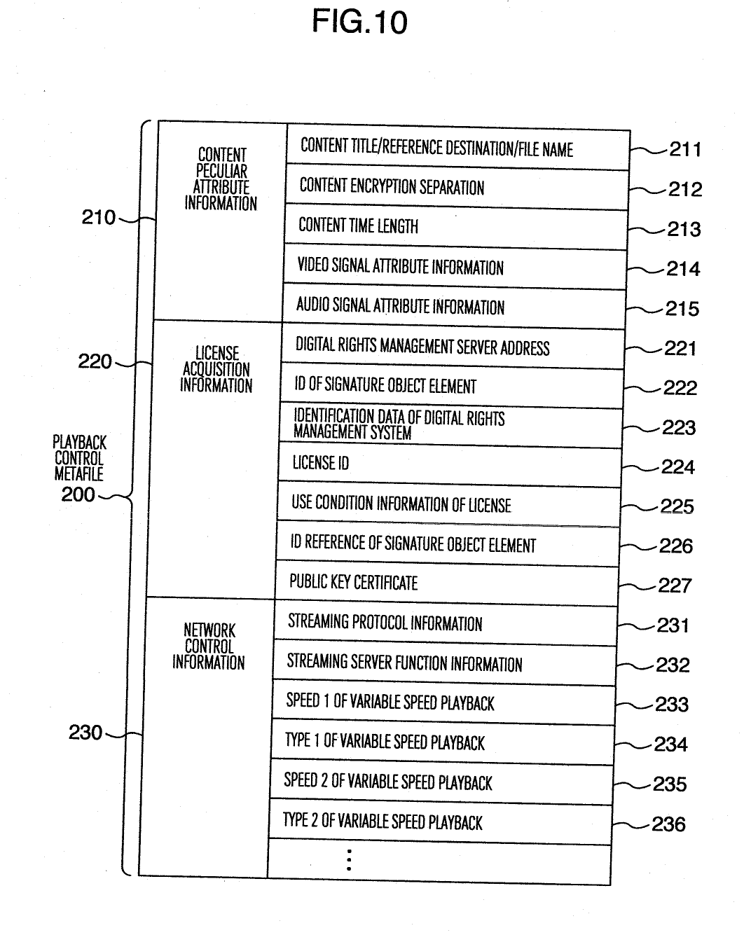

FIG. 10 illustrates a configuration example of the playback control metafile 200. A configuration of the playback control metafile 200 acquired by referring to the download control information 100 will be described.

The playback control metafile 200 includes three XML documents of content peculiar attribute information 210 being information of an AV stream of content itself necessary during the content playback, license acquisition information 220 necessary at the time of accessing a digital rights management server to decrypt a cipher of encrypted content and acquiring a content key for the decoding, and network control information 230 necessary for performing playback control in the case of streaming VOD. Note that the network control information 230 is unnecessary in the case of the download distribution.

The content peculiar attribute information 210 provides a file name and reference destination of a file of content itself 211, discrimination information for determining whether to encrypt content 212, a time length of content 213, attribute information of a video encoding system and a video signal such as resolution, scanning, and aspect ratio 214, and attribute information of an audio signal for discriminating stereo, mono, and multichannel 215.

The license acquisition information 220 of content provides information such as digital rights management server address information being a license acquisition destination of object content 221, type information of a digital rights management system 223, a license ID indicating a type of digital rights protection range attached to content 224, a value and reference destination 226 of a signature object element for verifying a server between a digital rights management server and a receiver as a client 222, use condition information of a license 225, and a public key certificate necessary for verifying a certain signature 227.

The network control information 230 describes information on an available streaming protocol system 231, special playback and program searching system of content 232, information indicating what magnification at each stage when variable speed playback at multiple stages is possible in a server function or various streaming server function information such as interrupted playback can be restarted on the way 233, and information on the playback system 234.

As a playback system, there are supposed a system for preparing and distributing a stream for exclusive use of variable speed playback on the server side, and a system for realizing a pseudo high-speed playback by skipping and playing back a still image included in a normal speed playback stream.

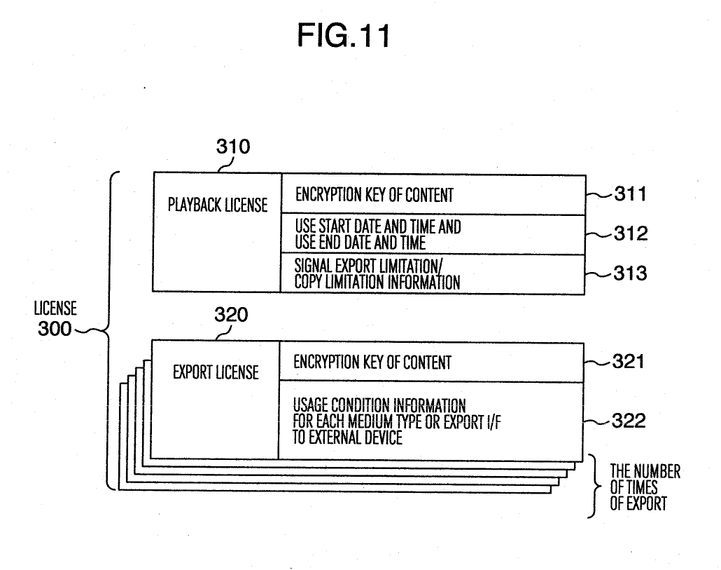

FIG. 11 illustrates a configuration example of the license 300. There will be described a configuration of the license 300 acquired by referring to the download control information 100, or acquired at the time of starting playback of content and at the time of starting export.

Examples of the license 300 include the playback license 310 describing a right for viewing a program and the export license 320 describing a right for exporting content to external media or networks.

The license 300 holds encryption keys 311 and 321 of content necessary for decoding content. In the case of the playback license 310, the license 300 holds a use start date and time and use end date and time 312, signal export limitation, and copy control information 313 during playback. The use start date and time and use end date and time 312 can be specified to an indefinite, i.e. parmanent, data and time.

For each exportable medium (or network), in the export license 320, there can be specified use condition information 322 such as a copy limitation and an analog export limitation in the case of exporting content to each medium.

In the export license 320, an export of once by using one license can be performed. Further, N number of export licenses 320 are distributed from the DRM server 64 to the receiver 50 so as to export one content N times.

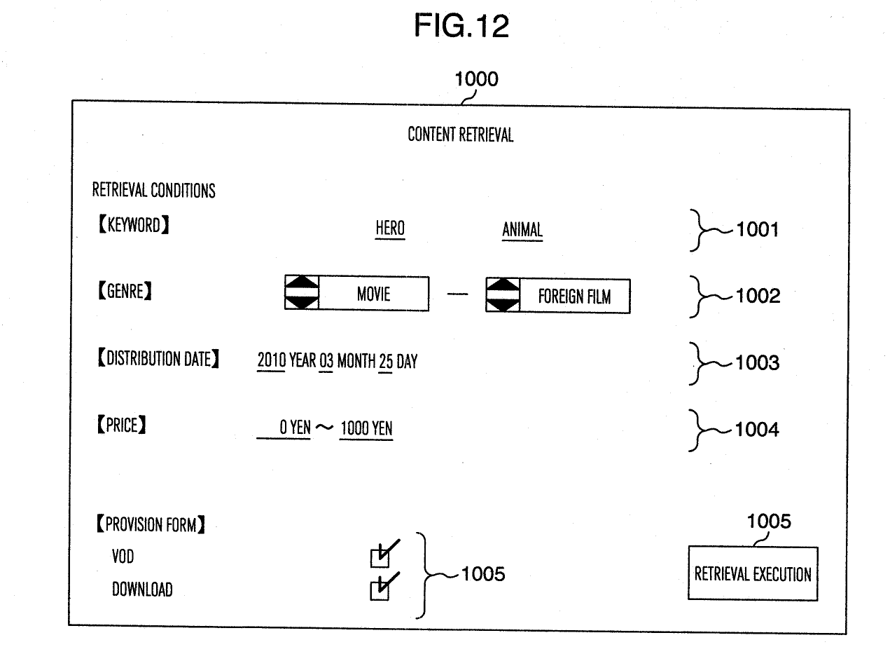

Next, a user interface example of receiver application realized based on the above-described system configuration and data configuration will be described with reference to FIGS. 12 to 19.

FIG. 12 illustrates an example of a content retrieval screen 1000 realized by the ECG processing unit 52.

In this screen started by the remote control, when options such as a keyword 1001, genre 1002, distribution date 1003, price 1004, and provision form 1005, and an input record field are prepared and further a retrieval start 1005 is instructed, the ECG metadata 400 is retrieved according to specification contents of the user.

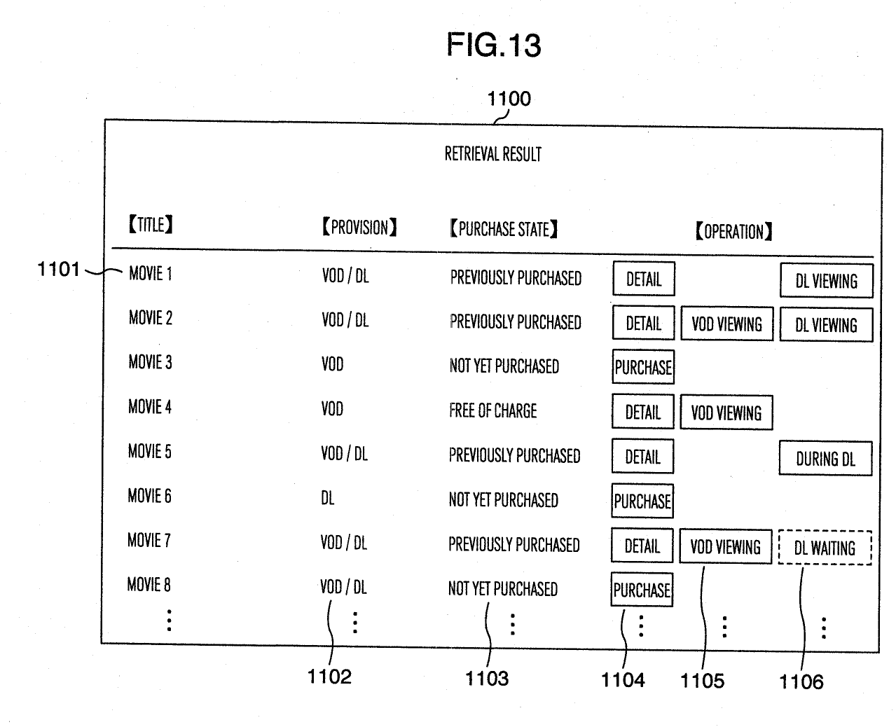

FIG. 13 illustrates a display example of a retrieval result screen 1100 displayed by the ECG processing unit 52. In this example, the ECG processing unit 52 list-displays retrieval results, and displays a title 1101, provision form 1102, and purchase state 1103. As manual operation buttons corresponding to content, the ECG processing unit 52 displays a purchase or detail button 1104, VOD viewing button 1105, and related DL, i.e. download, button 1106.

In the provision form field 1102, when content is provided to the package metadata 450 only by a VOD distribution (streaming distribution), “VOD” is assumed to be displayed. When content is provided to the package metadata 450 only by a download distribution, “DL” is assumed to be displayed. When content is provided to the package metadata 450 by both of them, “VOD/DL” is assumed to be displayed. Note that VOD means video on demand.

In the purchase state field 1103, the ECG processing unit 52 presents information managed by the receiver, such as content is previously purchased, not yet purchased by a user, or free of charge.

In the purchase or detail button 1104, when the content is not yet purchased, the “purchase” button is displayed. Further, when the content is not required to be purchased because it is previously purchased, or free of charge, the “detail” button is displayed.

The “VOD viewing” button 1105 is displayed only in the case where the content can be viewed by VOD (streaming), and when this button is selected, the VOD viewing is started.

The related DL button 1106 is displayed only in the downloadable content. When the download is instructed and the content fails to be downloaded according to states, the no-op “DL waiting” button is displayed. When the download is started, the “DL waiting” button is changed into the “during DL” button, and when the download is completed, the “DL viewing” is displayed. When the “DL viewing” button is selected, the downloaded content can be viewed. Even “during DL”, when buffered to some extent, the receiver may be used so as to view content.

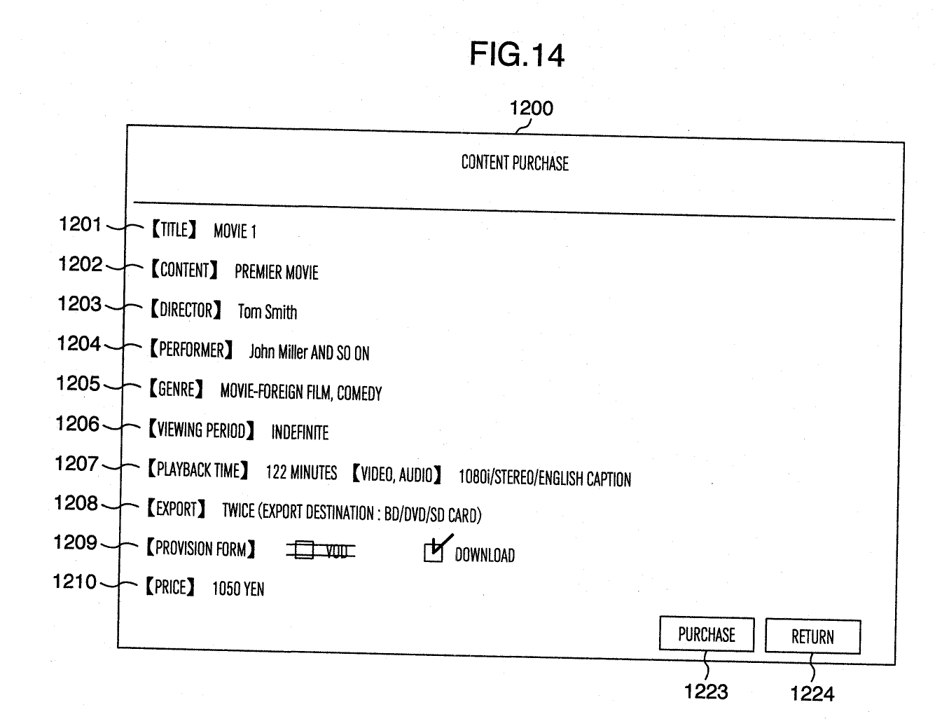

FIG. 14 illustrates an example of a content purchase screen 1200 displayed by the ECG processing unit 52. In the retrieval result screen 1100, in the case of selecting the “purchase” button, the ECG processing unit 52 presents the content purchase screen 1200.

The ECG processing unit 52 presents a title 1201 necessary for purchasing content, contents 1202, director 1203, performer 1204, genre 1205, viewing term 1206, information on playback time or video and audio 1207, information on export destination and the number of exportable times 1208, option of provision form 1209, and price 1210 by using as a base the ECG metadata 400. When the provision form 1209 can be selected, the VOD, download, or both of them can be selected.

In an example of FIG. 14, the “VOD” is displayed to be invalid by using deleted lines, and the “download” is displayed to be valid. Further, the download is displayed to be selected through a check mark by the user.

After the selection, when a “purchase” button 1223 is selected, a purchase transaction of the content is realized between the distribution system and the user.

When a “return” button 1224 is selected, the screen is assumed to be returned to the retrieval result screen 1100.

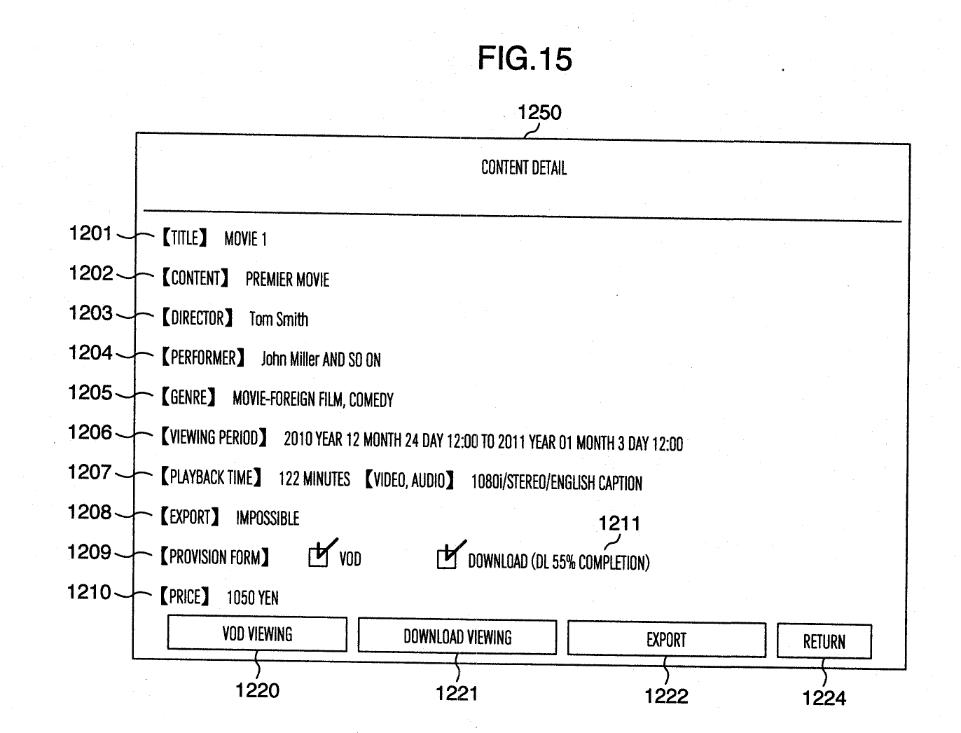

FIG. 15 illustrates an example of a content detail screen 1250 displayed by the ECG processing unit 52. After the content purchase, when the “detail” button is selected on the retrieval result screen 1100, the ECG processing unit 52 presents the content detail screen 1250.

Information on this screen is displayed approximately in the same manner as in the content purchase screen 1200, and since the screen displays a state after the purchase, the “purchase” button 1223 is eliminated. In place of the “purchase” button 1223, buttons such as the “VOD viewing” 1220, “download viewing” 1221, and “export” 1222 are displayed. Further, about content in which each function is effective, a button becomes effective and can be operated.

Further, in the field of the provision form 1209, the content cannot be selected because it is previously purchased, and therefore the provision form of the purchased content is only displayed. When the content can be downloaded and viewed, a progress 1211 of the download may be displayed.

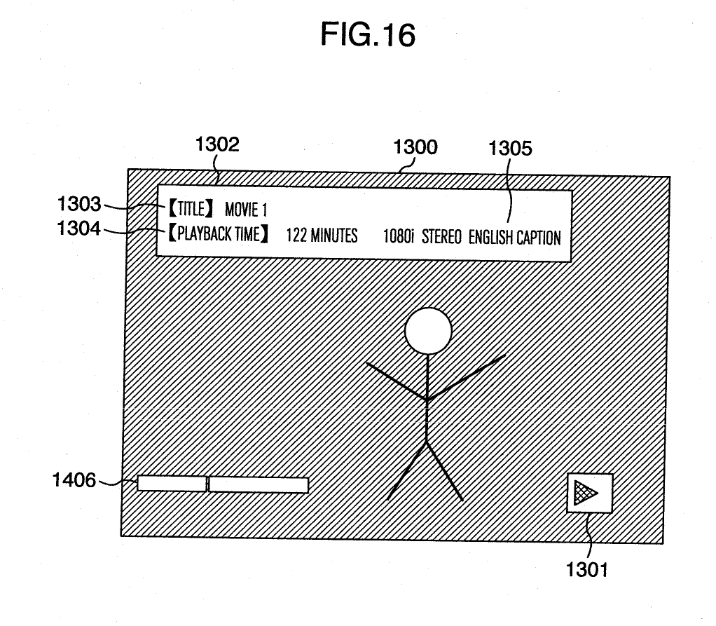

FIG. 16 illustrates an example of a content playback screen 1300 displayed by the ECG processing unit 52. On the content retrieval result screen 1100 or content detail screen 1250, in the case of selecting the VOD viewing or download viewing, the ECG processing unit 52 presents the content playback screen 1300.

Based on the playback control information 200, on the content playback screen 1300, a title 1303, playback time 1304, and detailed information of video and audio 1305 of the content are displayed on a title banner 1302. According to operations via a remote control, operation contents are icon displayed 1301. Further, some receivers display 1406 a current playback position in the entire playback time.

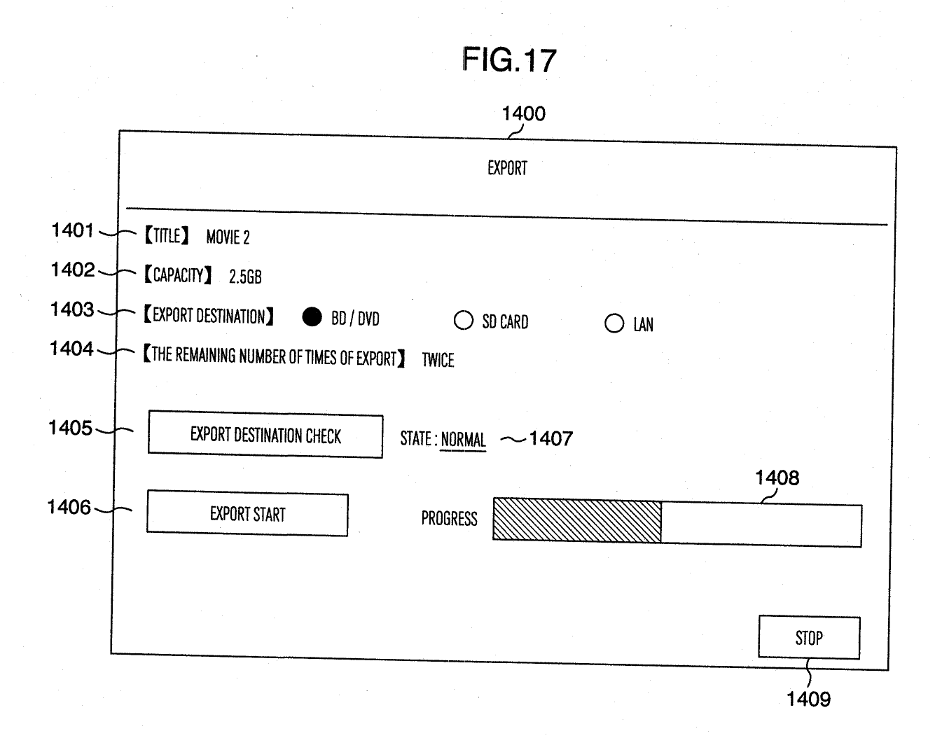

FIG. 17 illustrates an example of an export screen 1400 displayed by the ECG processing unit 52. When an export is instructed on the content detail screen 1250, the ECG processing unit 52 presents the export screen 1400.

Based on the ECG metadata 400, a title 1401 and capacity 1402 of the content are displayed on this screen. Further, an option of permissible export destination 1403 and the remaining number of times 1404 of export managed by the receiver are displayed.

When a user selects an export destination and further an “export destination check” button 1405, there is checked whether content desired to be exported can be recorded on a medium of the export destination. If YES, it is “normal”, and if NO, its cause is displayed on a state field 1407.

Also in the case of selecting the “export start” button 1406, a previous check is performed in the same manner as in the case of selecting the “export destination check” button 1405. If there is a problem, its cause is displayed on the state field 1407. In the case of selecting the “export start” button 1406, if it is normal, the export is started.

Progress of the export is displayed as a progress state 1406. When the export is completed, an export screen 1400 in which the remaining number of times 1404 is reduced by one time is assumed to be displayed.

When the export is stopped before completion of the export and a screen is desired to be returned to the content detail screen 1250, a “stop” button 1409 is selected.

As described above, an ECG screen formed by the ECG processing unit 52 is configured. In another embodiment, in place of the ECG processing unit 52, when presenting the web document 71 acquired from the web server 61, the browser 51 can perform an operation from retrieval to playback of content.

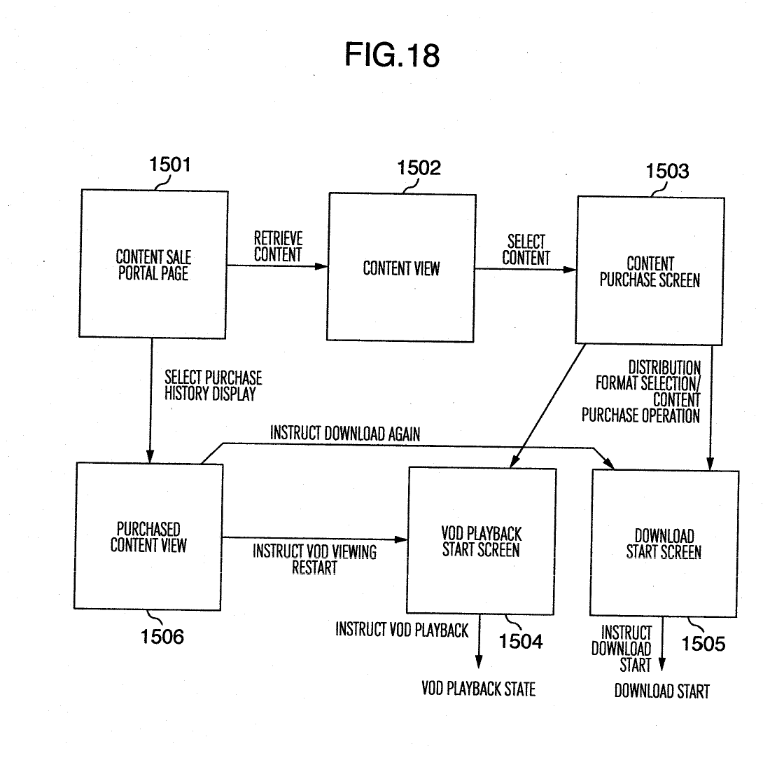

FIG. 18 illustrates a transition example of the web document 71 presented on the browser 51.

When selection of a home page during start of the browser 51 and a bookmark is received, the browser 51 first displays a content sales portal page 1501. Here, when retrieval of the content is instructed, the browser 51 displays a content list page 1502 of the retrieval result. Further, when selecting content from the retrieval result, the browser 51 displays a content purchase page 1503.

On a content purchase screen 1503, when a purchase is selected by using the VOD according to a distribution form in which a distribution form is selected and content is purchased, the browser 51 displays a VOD playback start page 1504. When a VOD playback is instructed, the browser 51 refers to the playback control metafile 200 and displays the content playback screen of FIG. 16.

Further, when a purchase through the download is selected on the content purchase screen 1503, the browser 51 displays the download start page 1505. When instructing a download start, the browser 51 starts a download of the content on the background based on the download control information 100.

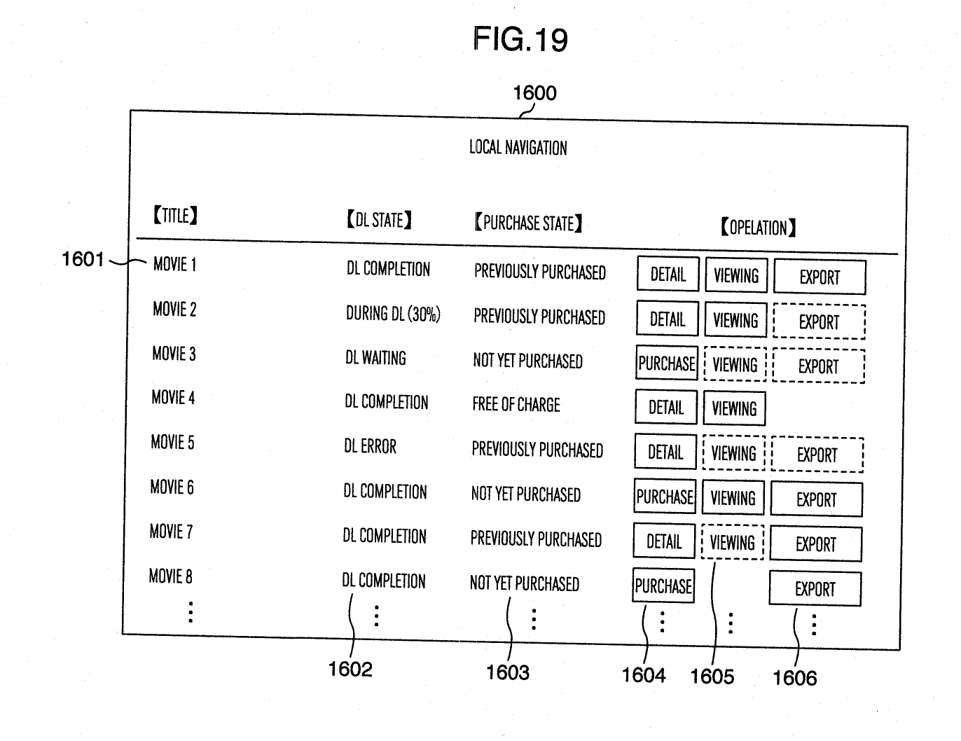

FIG. 19 illustrates a local navigation screen 1600 displayed by the browser 51. A state of the download-distributed content is displayed on the local navigation screen 1600.

On this screen, content in which a download is instructed and downloaded content are displayed in listing. A title of the content 1601, a download state 1602, a purchase state 1603, and a “purchase” or “detailed” button 1604 as an operation button is displayed with respect to content. Further, as purchase conditions, a “viewing” button 1605 is displayed with respect to viewable content and an “export” button 1606 is displayed with respect to exportable content.

In the download state field 1602, there are performed state displays such as “DL waiting” in the seeming download state in which a download is instructed, “during DL” in which a download is started and also its progress is displayed, “DL completion” in which a download is completed, and “DL error” in which an error occurs during the download and which is stopped.

In the purchase state field 1603, states such as not yet purchased, previously purchased, and free of charge are displayed.

With regard to button types, the “purchase” button is displayed with respect to not yet purchased content, and the “detailed” button is displayed with respect to previously purchased content. In the viewing button, when a download is completed or buffering progresses to replayable extent even during the download, the viewing button becomes an effective display and can be selected. Further, when the content turns to an exportable state, the “export” button 1606 becomes an effective display and can be selected.

When the “viewing” button 1605 is selected, the screen transits to the content viewing screen 1300. When the “export” button 1606 is selected, the screen transits to the export screen 1400.

Through the above processing, operations from the retrieval to the playback of content can be performed on the web site.

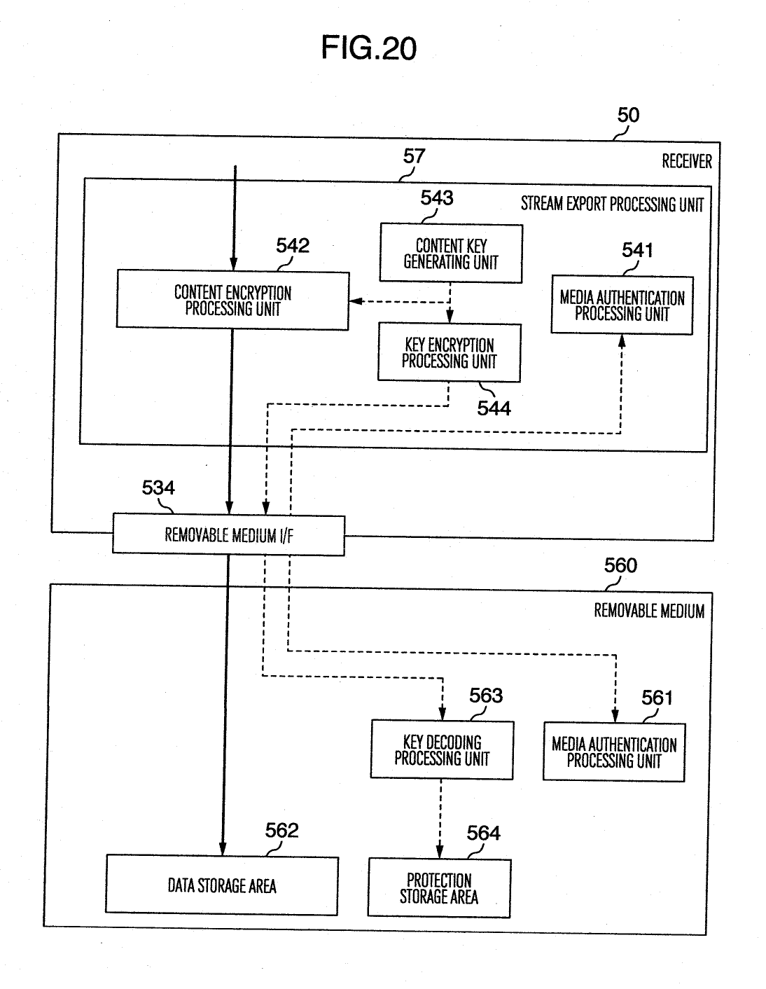

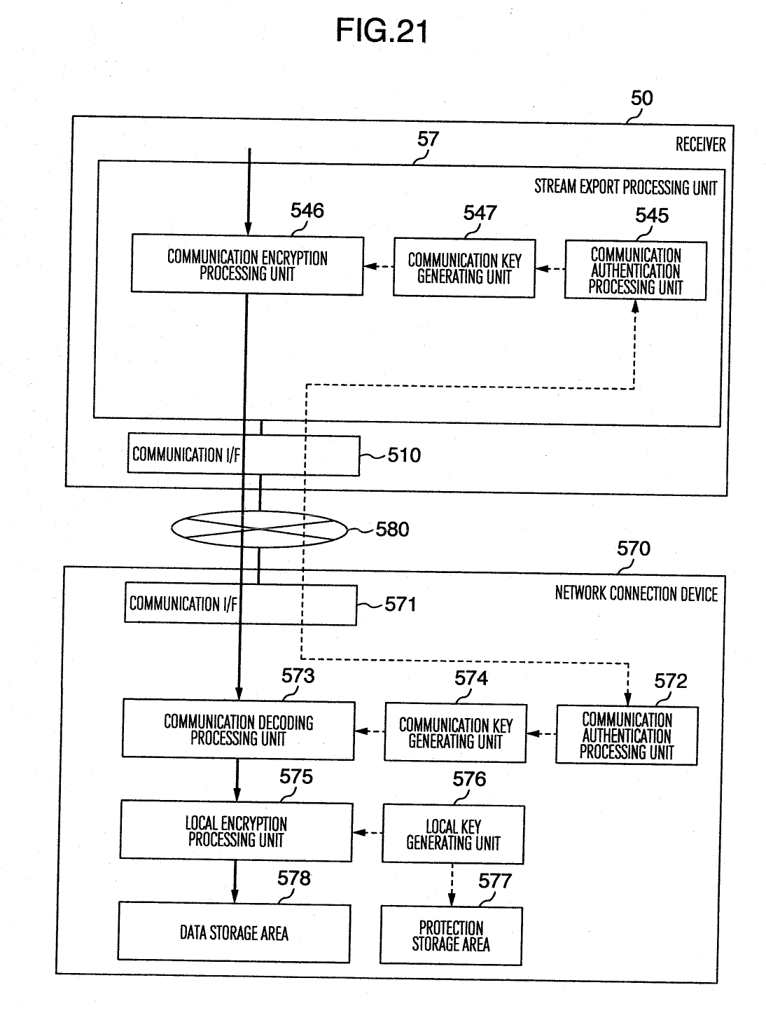

Next, export processing will be described in detail with reference to FIGS. 20 and 21.

FIG. 20 illustrates a configuration example of an interface portion between the receiver and the removable medium. As the removable medium, a removable HDD such as iVDR (trademark) is supposed. However, the removable medium is not limited to the iVDR.

In the figure, a solid line arrow indicates a flow of the content, and a dash line arrow indicates a flow of the control.

FIG. 20 illustrates a configuration example of the stream export processing unit 57 which performs export processing to the removable medium 560 having a digital rights protection function. The stream export processing unit 57 of the receiver 50 includes a media authentication processing unit 541 which performs authentication with the removable medium, a content key generating unit 543 which generates an encryption key for encrypting content to be transferred to a medium, a content encryption processing unit 542 which encrypts the content based on a content key, and a key encryption processing unit 544 which encrypts the generated content key and transfers it to the removable medium.

Content to be supplied to the content encryption processing unit 542 is supplied from the descriptor 514 or demultiplexer 521 of the receiver 50.

All or part of the media authentication processing unit 541, content key generating unit 543, content encryption processing unit 542, and key encryption processing unit 544 illustrated in FIG. 20 are converted into an integrated circuit as a processing unit performing each processing to thereby be realized by using hardware. Further, a media authentication processing program 541, content key generating program 543, content encryption processing program 542, and key encryption processing program 544 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by hardware, it performs each processing as a subject.

In the removable medium 560 connected via the removable I/F 534, information representing the received content key and use conditions (the number of times of copy and available term) of content is stored correspondingly to the content in a media authentication processing unit 561 which mutually performs authentication with the media authentication processing unit 541 of the receiver 50, a key decoding processing unit 563 which receives and decodes the encrypted content key and takes out the content key, and a protection storage area 564 capable of being read and written only by the receiver 50 with confidence of two-way authentication.

Here, the number of times of copy represents the number of times of the recorded content to be further duplicated. When the number is M, M+1 content can be used in addition to the original content itself. The available term indicates a use term, i.e. usage conditions, of content in the removable medium, and the following method can be described.

(1) A relative time from a time point at which content is written in the removable medium

(2) A relative time from a time point at which a user first accesses content in the removable medium

(3) Absolute use start date and time and use end date and time (both can be omitted, and the omitted use start date and time and use end date and time are considered to have no limitation)

All or part of the media authentication processing unit 561 and key decoding processing unit 563 illustrated in FIG. 20 are converted into an integrated circuit as a processing unit performing each processing to thereby be realized by using hardware. Further, the media authentication processing program 561 and key decoding processing program 563 stored in the data storage area 562, the protection storage area 564, or memory areas (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

Content encrypted by the media encryption processing unit 542 is stored in the data storage area 562 via the removable I/F 534.

In the media authentication processing unit 541, there are considered a case of authenticating reliability of the removable medium 560 and a case of authenticating reliability of both the removable medium 560 and the receiver 50 having the removable I/F 534.

When reading out the content stored in the removable medium 560, the mutually authenticated receiver 50 reads out a content key of the content from the protection storage area 564. Further, the content read out and encrypted from the data storage area 562 is decoded by using the content key in the receiver 50 to thereby be used.

FIG. 21 illustrates a configuration example of an interface portion between the receiver and the network connection device. FIG. 21 illustrates a configuration example of the stream export processing unit 57 which performs export processing via a network having a digital rights protection function. In this case, the stream export processing unit 57 of the receiver 50 includes a communication authentication processing unit 545 which performs mutual authentication with the network connection device, a communication key generating unit 547 which generates a communication key for encrypting content based on a common key replaced during the authentication, and a communication encryption processing unit 546 which encrypts content based on the generated communication key and sends out the encrypted content via the communication I/F 510.

All or part of the communication authentication processing unit 545, communication encryption processing unit 546, and communication key generating unit 547 illustrated in FIG. 21 are converted into an integrated circuit as a processing unit performing each processing to thereby be realized by using hardware. Further, a communication authentication processing program 545, communication encryption processing program 546, and communication key generating program 547stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

The network connection device is connected to a network 580 via a communication I/F 571, and communicates with the receiver 50.

The communication authentication processing unit 572 performs mutual authentication with the communication authentication processing unit 545 of the receiver 50. The communication key generating unit 574 generates a communication key for decoding content based on a common key replaced during the authentication. The communication decoding processing unit 573 decodes the content received via the communication I/F 510 based on the generated communication key.

In an example of FIG. 21, the content decoded by the communication decoding processing unit 573 is encrypted by a local encryption processing unit 575 based on an encryption system of the network connection device 570, and is stored in a data storage area 578 of the network connection device 570. The encryption key at this time is generated by a local key generating unit 576. Further, information indicating a local key corresponding to the content and use conditions (the number of times of copy and available term) of the content is stored in a protection storage area 577 accessible only by reliable devices and software.

All or part of the communication decoding processing unit 573, communication key generating unit 574, local encryption processing unit 575, and local key generating unit 576 illustrated in FIG. 21 are converted into an integrated circuit as a processing unit performing each processing to thereby be realized by using hardware. Further, a communication decoding processing program 573, communication key generating program 574, local encryption processing program 575, and local key generating program 576 stored in the data storage area 578, the protection storage area 577, and memory areas (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

In an example of FIG. 21, the network connection device 570 has the data storage area 578 peculiar to the device. Further, the network connection device 570 may have the removable I/F 534 as in the receiver 50 of FIG. 20 and transfer content received via a network to the removable medium 560 via the removable I/F 534. A configuration of the network connection device 570 in that case is pursuant to that of the receiver 50 of FIG. 20.

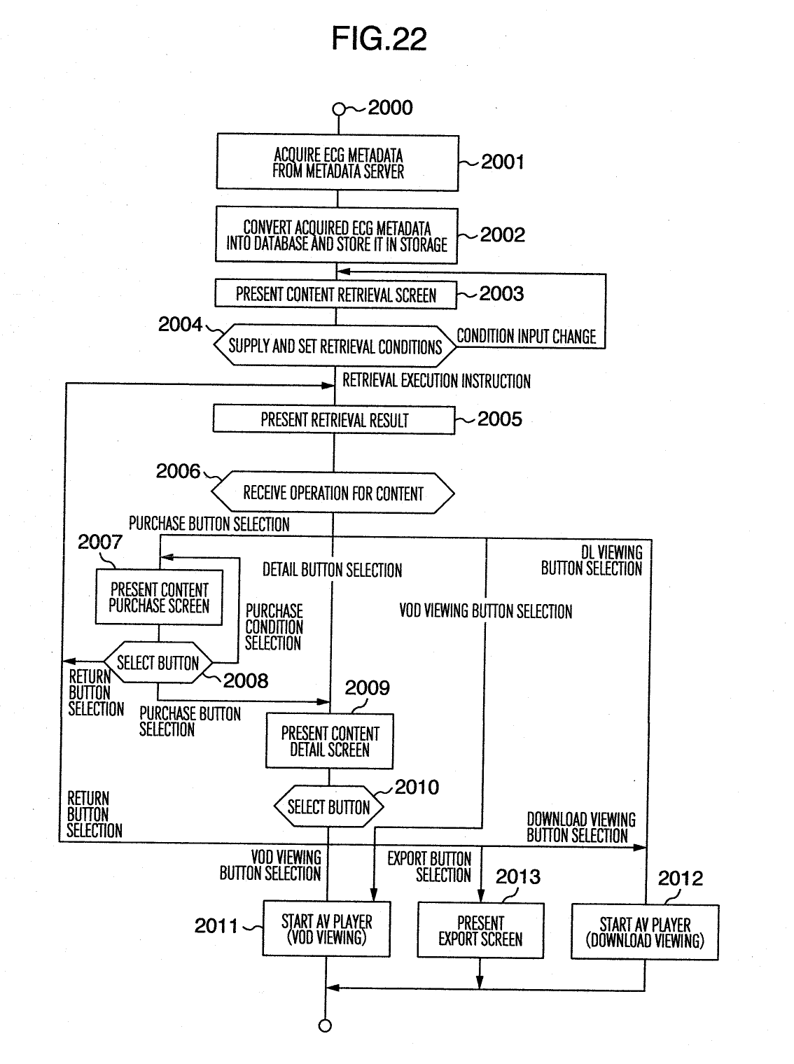

As described above, an example of the receiver corresponding to the content distribution will be described by using an example of the processing performed by the receiver with reference to FIGS. 22 to 25.

FIG. 22 illustrates an example of a process flowchart 2000 of the ECG processing unit 52.

The ECG processing unit 52 acquires ECG metadata from a metadata server (S2001: S represents a step). Further, the ECG processing unit 52 makes a database of the acquired ECG metadata into a form easy for data processing, stores it in the storage (S2002), an presents the content retrieval screen 1000 (S2003).

Here, the ECG processing unit 52 supplies and sets retrieval conditions (S2004), and when a user instructs a retrieval execution, the ECG processing unit 52 presents the retrieval result screen 1100. On this screen, the ECG processing unit 52 receives an operation for content (S2006), and when the “purchase button” is selected, the ECG processing unit 52 displays the content purchase screen 1200 (S2007). On this screen, when the user selects purchase conditions and further the purchase button (S2008), the ECG processing unit 52 displays the content detail display screen 1250 (S2009). The content detail display screen 1250 is displayed even when the “detail” button is selected from the retrieval result screen 1100.

When a user selects the “VOD viewing” button from the retrieval result screen 1100, the ECG processing unit 52 starts the AV player 53 and the VOD viewing is started (S2011). When the user selects the “DL viewing” button, the ECG processing unit 52 starts the AV player 53 and the download viewing is started (S2012).

On the content detail display screen 1250, when a user selects the “VOD viewing” button, the ECG processing unit 52 starts the AV player 53 and the VOD viewing is started (S2011). When the user selects the “DL viewing” button, the ECG processing unit 52 starts the AV player 53 and the download viewing is started (S2012). When the user selects the “export” button, the screen transits to the export screen 1400 (S2013).

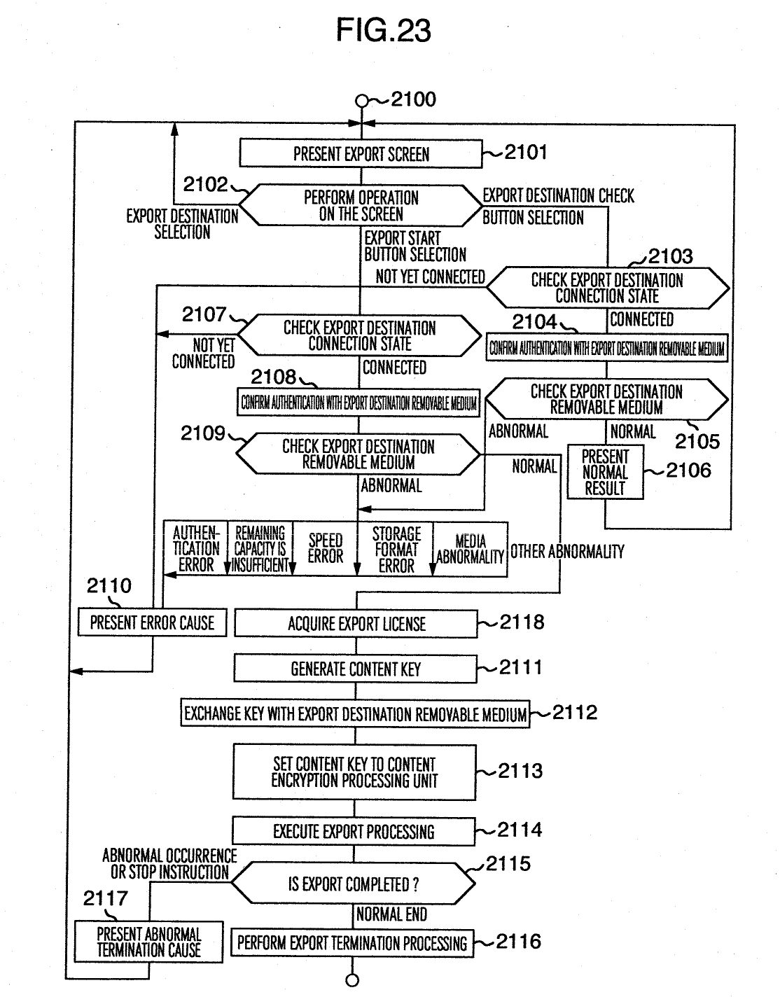

FIG. 23 illustrates an example of a process flowchart of the stream export processing unit 57 in the case of exporting content to the removable medium 560 in the export screen 1400.

After the stream export processing unit 57 presents the export screen 1400 (S2101), a user selects an export destination and further an “export destination check” button by an operation on the screen (S2102). The stream export processing unit 57 checks whether the removable medium 560 is connected to an export destination (S2103). If NO, the stream export processing unit 57 presents an error message indicating that the removable medium 560 is not yet connected to the export destination (S2110).

If YES, the media authentication processing unit 541 then confirms authentication with the removable medium 560 as the export destination (S2104), and performs a detailed check of the removable medium 560 (S2105). Here, if abnormality to describe content is absent, the media authentication processing unit 541 presents a normal result (S2106). If the abnormality is present, the media authentication processing unit 541 presents an error cause (S2110), and the process returns to an operation reception state of an export screen (S2102).

As the error of this time, various causes are considered as follows: for example, an authentication error caused by the removable medium 560 or receiver 50 side, an error in which the remaining capacity necessary for describing content is insufficient, a speed error of the removable medium 560 failing to satisfying a speed necessary for playing back content, a storage format error in the case where a file format regulated by the removable medium 560 is not adapted to content storage, and abnormality in reading and writing of the removable medium 560.

On the export screen 1400, when a user selects the “export start” button, the stream export processing unit 57 checks whether the removable medium 560 is connected to an export destination (S2107). If NO, the stream export processing unit 57 presents an error message indicating that the removable medium 560 is not yet connected to the export destination (S2110). If YES, the stream export processing unit 57 then confirms authentication with the removable medium 560 as the export destination (S2108), and performs a detailed check of the removable medium 560 as the export destination (S2109). Here, if abnormality to describe content is present, the stream export processing unit 57 presents an error cause (S2110), and the process returns to an operation reception state of the export screen (S2102). If the abnormality is absent, the process moves to the export processing.

In the export processing, the DRM client 54 first acquires the export license 320 from the DRM server 64 (S2118). The content key generating unit 543 then generates a content key (S2111). The key encryption processing unit 544 encrypts the generated content key and exchanges the key with the removable medium 560 as the export destination (S2112). The content key generating unit 543 further sets the content key to the content encryption processing unit 542 (S2113). The content encryption processing unit 542 performs the export processing to the removable medium 560 (S2114).

When the content encryption processing unit 542 completes the export processing (S2115), the media authentication processing unit 561 stores the content key and use condition information of the content in the removable medium 560, and updates the file management information in the export termination processing (S2116). The media authentication processing unit 561 enables the reading and writing of the removable medium 560 also in other receivers. Before completion of the export processing, when the export processing is not normally completed due to a stop instruction of a user, and an abnormality occurrence of the removable medium 560, the media authentication processing unit 561 presents the cause of an abnormal termination (S2117), and the process returns to a presentation of the export screen (S2101).

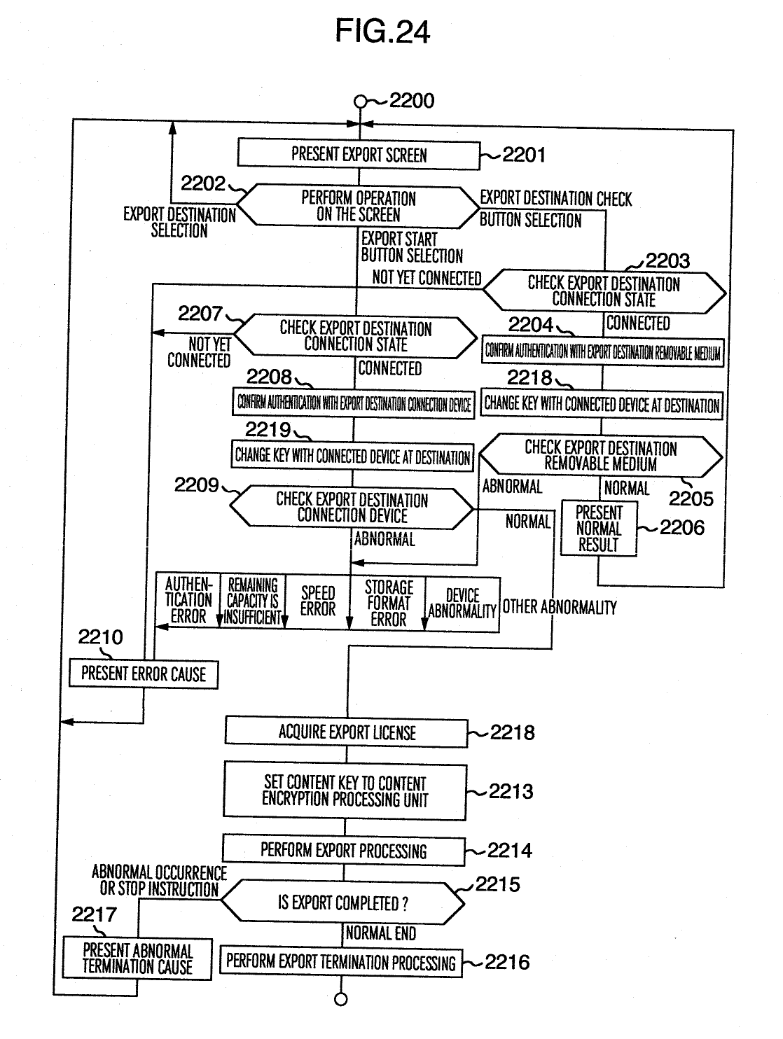

FIG. 24 illustrates an example of a process flowchart of the stream export processing unit 57 in the case of exporting content to the network connection device 570 in the export screen 1400.

After the stream export processing unit 57 presents the export screen 1400 (S2201), a user selects an export destination and further an “export destination check” button by an operation on the screen (S2202). The communication authentication processing unit 545 checks whether the network connection device 570 is connected to an export destination (S2203). If NO, the stream export processing unit 57 displays an error message indicating that the network connection device 570 is not yet connected to the export destination (S2210). If YES, the communication authentication processing unit 545 then confirms authentication with the network connection device 570 as the export destination (S2204), and performs a detailed check of the network connection device 570 (S2105). Here, if abnormality to describe content is absent, the communication authentication processing unit 545 presents a normal result (S2106). If the abnormality is present, the communication authentication processing unit 545 presents an error cause (S2110), and the process returns to an operation reception state of the export screen (S2102).

Also as the error in this case, various causes are considered in the same manner as in the export processing to the removable medium 560: for example, an authentication error caused by the network connection device 570 or receiver 50 side, an error in which the remaining capacity of the network connection device 570 side necessary for storing content is insufficient, a speed error of the network connection device 570 failing to satisfying a speed necessary for playing back content, a storage format error in the case where a file format regulated by the network connection device 570 is not adapted to content storage, and device abnormality of the network connection device 570.

On the export screen 1400, when a user selects the “export start” button, the communication authentication processing unit 545 checks whether the removable medium 560 is connected to an export destination (S2207). If NO, the communication authentication processing unit 545 displays an error message indicating that the removable medium 560 is not yet connected to the export destination (S2210). If YES, the communication authentication processing unit 545 then confirms authentication with the network connection device 570 as an export destination (S2208), and performs a detailed check of the network connection device 570 as the export destination (S2209). Here, if abnormality to describe content is present, the communication authentication processing unit 545 presents an error cause (S2210), and the process returns to an operation reception state of the export screen (S2202). If the abnormality is absent, the process moves to the export processing.

In the export processing, the DRM client 54 first acquires the export license 320 from the DRM server 64 (S2218). The DRM client 54 further sets to the communication encryption processing unit 546 the communication key generated by using as a base the exchanged key during the mutual authentication by the communication authentication processing unit 545 (S2213). The communication encryption processing unit 546 performs the export processing to the network connection device 570 (S2214).

When the export processing is completed (S2215), the stream export processing unit 57 closes the communication session in the export termination processing (S2216). Before completion of the export processing, when the export processing is not normally completed due to a stop instruction of a user, and an abnormality occurrence of the network connection device 570, the stream export processing unit 57 presents the cause of an abnormal termination (S2217), and the process returns to a presentation of the export screen (S2201).

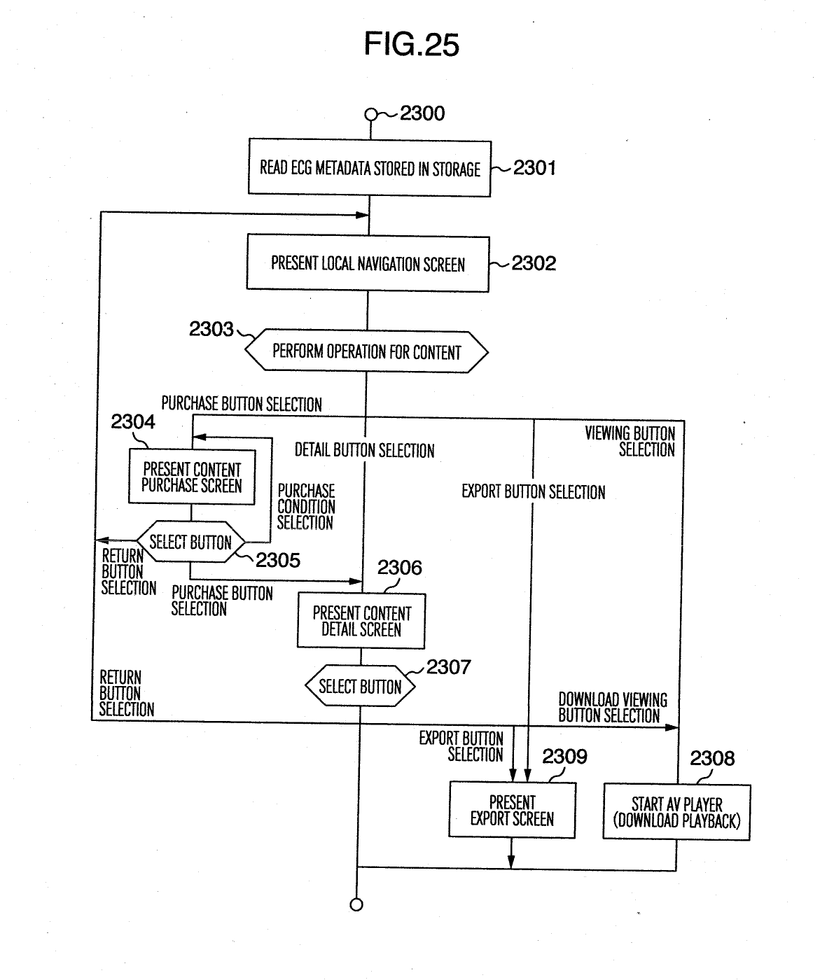

FIG. 25 illustrates an example of a process flowchart of the ECG processing unit 52 on the local navigation screen 1600 of FIG. 19.

On the local navigation screen 1600, the ECG processing unit 52 reads out the ECG metadata on the content of the download distribution stored in the storage unit (not illustrated) (S2301). Based on the above information, the ECG processing unit 52 presents the local navigation screen 1600 (S2302).

In the above-described state, the ECG processing unit 52 receives an operation of the user (S2303). When the user selects the “purchase” button, the ECG processing unit 52 displays the content purchase screen 1200 (S2304). When the user selects purchase conditions and further the purchase button on this screen (S2305), the ECG processing unit 52 displays the content detail display screen 1250 (S2306). The content detail display screen 1250 is displayed also by selecting the “detailed” button from the local navigation screen 1600.

When the user selects the “viewing” button from the local navigation screen 1600, the ECG processing unit 52 starts the AV player 53 and the download viewing is started (S2308). When the user selects the “export” button, the screen transits to the export screen 1400 (S2309).

Also on the content detail display screen, when the “viewing” button is selected based on an operation of the user (S2307), the ECG processing unit 52 starts the AV player 53 and the download viewing is started (S2308). When the “export” button is selected, the screen transits to the export screen 1400 (S2309).

According to the above-described embodiment, the receiver 50 can acquire and view content from the distribution system 60 connected via the network through the ECG displayed on the ECG processing unit 52, the web screen displayed on the browser 51, or the local navigation 1600.

In FIGS. 22 and 25, the case where content is viewed or exported is described with reference to the content retrieval screen generated by the ECG processing unit 52, or the local navigation screen; however, it is not limited thereto. The browser 51 may generate the content retrieval screen or the local navigation screen and perform the same processing. Alternatively, the AV player 53 may generate the content retrieval screen or the local navigation screen and perform the same processing.

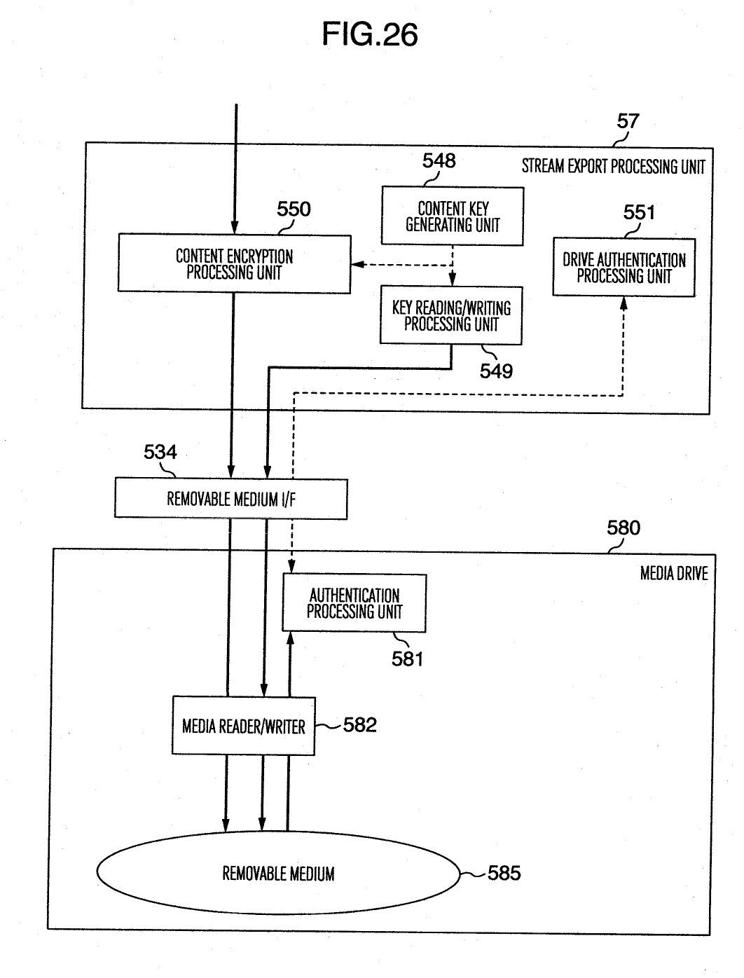

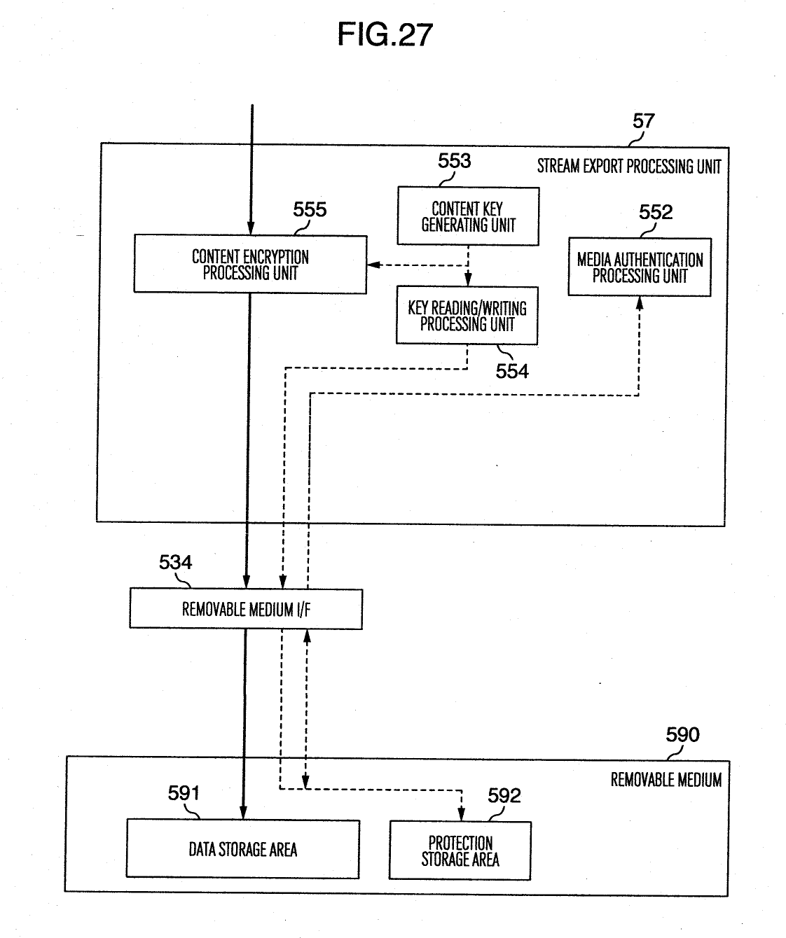

Examples of other removable media used by the receiver 50 are illustrated in FIGS. 26 and 27.

FIG. 26 illustrates an example in the case where the removable medium is an optical disk medium. To the removable medium I/F 534, the media drive 580 is connected, and the removable medium 585 is inserted into the media drive 580 to thereby perform reading/writing via a media reader/writer 582.

The stream export processing unit 57 includes a drive authentication processing unit 551, a content key generating unit 548, a key reading/writing processing unit 549, and a content encryption processing unit 550.

When the removable medium 585 having a digital rights protection function is inserted into the media drive 580 having a digital rights protection function, digital rights-protected content can be read or written. Between an authentication processing unit 581 of the media drive 580 and the drive authentication processing unit 551, the stream export processing unit 57 of the receiver 50 performs authentication processing whether the removable medium 585 and the media drive 580 correspond to the digital rights protection.

After the authentication establishment, the stream export processing unit 57 sets a key generated by the content key generating unit 548 to the content encryption processing unit 550, encrypts the content, and writes the encrypted content in the removable medium 585. Further, through the key reading/writing processing unit 549, the stream export processing unit 57 writes information indicating a media key used for encryption and use conditions (the number of times of copy and available term) of content in the removable medium 585.

All or part of the drive authentication processing unit 551, content key generating unit 548, content encryption processing unit 550, and key reading/writing processing unit 549 illustrated in FIG. 26 are converted into an integrated circuit as a processing unit performing each processing to thereby be realized by using hardware. Further, a drive authentication processing program 551, content key generating program 548, content encryption processing program 550, and a key reading/writing processing program 549 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by using hardware, it performs each processing as a subject.

All or part of the media reader/writer 582 and authentication processing unit 581 illustrated in FIG. 26 are converted into an integrated circuit as a processing unit performing each processing to thereby be realized by using hardware. Further, a media reader/writer program 582, and authentication processing program 581 stored in the memory areas (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by hardware, it performs each processing as a subject.

FIG. 27 illustrates an example of the case where the removable medium is a memory card, and the removable medium 590 is connected directly to the removable medium I/F 534.

The stream export processing unit 57 includes a media authentication processing unit 552, a content key generating unit 553, a key reading/writing processing unit 554, and a content encryption processing unit 555.

The removable medium 590 includes a general data storage area 591 and a protection storage area 592 which holds a key for encrypting data. The media authentication processing unit 552 determines, based on the presence or absence of the protection storage area 592, whether the removable medium 590 corresponds to the digital rights protection. After the authentication establishment, the media authentication processing unit 552 sets the key generated by the content key generating unit 553 to the content encryption processing unit 555. The media authentication processing unit 552 encrypts content and writes the encrypted content in the data storage area 591 of the removable medium 590. Through the key reading/writing processing unit 554, the media authentication processing unit 552 further stores information indicating a used media key and use conditions (the number of times of copy and available term) of content in the protection storage area 592.

All or part of the media authentication processing unit 552, content key generating unit 553, content encryption processing unit 555, and key reading/writing processing unit 554 illustrated in FIG. 27 are converted into an integrated circuit as a processing unit performing each processing to thereby be realized by using hardware. Further, a media authentication processing program 552, content key generating program 553, content encryption processing program 555, and key reading/writing processing program 554 stored in the storage 550 or storage device such as memories (not illustrated) are processed by using an arithmetic processor such as a central control unit (not illustrated). As a result, all or part of each processing can be realized by using software.

For ease of explanation, each processing realized by executing various programs through the central control unit will be described by using as a subject each processing unit realized by programs. When each processing unit is realized by hardware, it performs each processing as a subject.

The above-described embodiment permits the receiver 50 to export the received content 75 and digital right-protected content with respect to removable media having various shapes.

### Second Embodiment

In the present embodiment, when exporting distributed content to a removable medium, while giving export conditions such as the number of times of copy and use term, an example of a receiver to be exported will be described.

A definition of export functions realized in the present embodiment is illustrated in table 1.

TABLE 1

| No. | Classification | | Contents | Preconditions |
|---|---|---|---|---|
| 1 | Simple export | | Content is exported to a | When content protected by |
| | | | removable medium or an | DRM is exported, it can be |
| | | | external interface by the | copied to only an export |
| | | | number of exportable | destination permitted by |
| | | | times determined by a | DRM. |
| | | | purchase contract to | |
| | | | thereby prepare copies. | |
| 2 | Expanded | Export with the | The arbitrary number of | Export with the number of |
| | export | number of times | multiple times within the | times of copy is possible |
| | | of copy | number of exportable | only in the case where a |
| | | | times determined by the | medium of an export |
| | | | purchase contract is given | destination has a digital |
| | | | and exported to one | rights protection function |
| | | | content entity as | capable of managing the |
| | | | management information | number of times of copy. |
| | | | on the number of times of | |
| | | | copy. | |
| 3 | | Export with usage | Term information of | Export with use term is |
| | | conditions | content of export | possible only in the case |
| | | | destination determined by | where a medium of an |
| | | | the purchase contract is | export destination has a |
| | | | given and exported as term | digital rights protection |
| | | | management information. | function capable of |
| | | | | performing a term |
| | | | | management such as use |
| | | | | start term and use end term. |

In a simple export, content is exported to a removable medium or an external interface by the number of exportable times determined by a purchase contract to thereby prepare copies. In the removable medium or a connection device of an external interface, copied content is managed by a digital rights protection function of a copy destination.

Further, as an expanded export function, an export function with a use term is supposed as follows. That is, the arbitrary number of multiple times within the number of exportable times determined by a purchase contract is given to one content entity as management information on the number of times of copy. Further, an export function with the number of times of copy to be exported and term information of export determined by the purchase contract are given as term management information to a removable medium or the connection device of an external interface. Further, content is export to the removable medium or the connection device of an external interface.

Screen configuration examples of FIGS. 1 to 11, 21, 22, 26, and 27 according to the second embodiment are illustrated in the same manner as in the first embodiment.

Since configurations to which the same reference numerals as those of the configurations illustrated in figures according to the first embodiment are attached each have the same function, their descriptions are omitted.

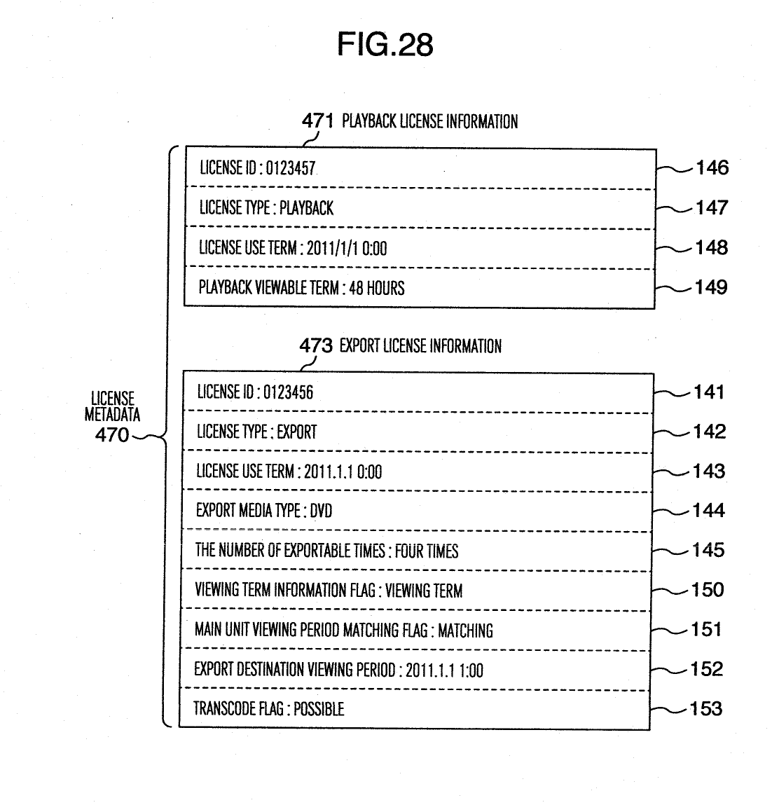

FIG. 28 illustrates a detailed configuration of the license metadata 470 illustrated in FIG. 7. In the license metadata 470, for example, when both of an export license and a playback license are attached to certain content, two right information units of the playback license information 471 and the export license information 473 are represented.

The license acquired from the digital rights management server 2 is uniquely identified by the license ID of 141 and 146. Further, the export license or playback license is identified by a license type of 142 and 147.

License use terms of 143 and 148 indicate a term capable of acquiring a license from the digital rights management server 2.

The export license has information such as an export media identification 144, the number of exportable times 145, viewing term information flag 150, main unit viewing period matching flag 151, export destination viewing period 152, and transcode flag 153. The playback license has information such as a playback viewable term 149.

In the export media identification 144, an exportable medium is specified. In the number of exportable times 145, the number of exportable times is specified to the medium specified by the export media identification 144.

The viewing period information flag 150 is information representing whether to export content with the viewing period during the export. In the case of exporting content with the viewing period, its period information is specified to the export destination viewing period 152.

The main unit viewing period matching flag 151 is a flag showing whether to perform an operation for matching a viewing period in a medium as the export destination with the export destination viewing period 152 of the playback license. In the case of indicating a value for matching the viewing period with the export destination viewing term 152, the viewing term information eliminates the need to be described in the export destination viewing period 152. When the playback viewable period 149 of the playback license is described, the period information can be used as the viewing period during the export.

There is performed an operation for matching the use period for viewing the main unit with the use period in the medium as an export destination. In the above-described case, when metadata for viewing the main unit is shared and used as the metadata during the export, capacity of the metadata can be reduced. In an example of FIG. 28, a value of “2010.1.1 1: 00” is described in the export destination viewing period. However, in the case of indicating a value for matching the viewing period with the export destination viewing period 152 through the main unit viewing period matching flag 151, the viewing period information eliminates the need to be described in the export destination viewing period 152, and a field for the value may be empty.

The description format of the export destination viewing period 152 and the playback viewable term 149 is an absolute date and time, and further the following description method is allowed: a case of specifying the date and time as in A year B month C day D hour E minute F second to G year H month I day J hour K minute L second, a case of performing a relative specification by using as a base point an immediate aftermath of export as in M hour N minute 0 second after the export, and a case of combining both the above cases as in G year H month I day J hour K minute L second after the export.

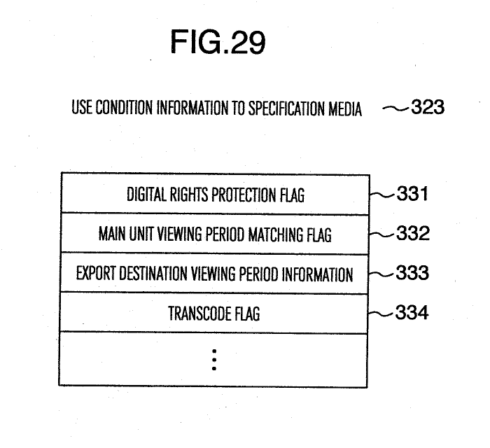

FIG. 29 illustrates a detailed configuration example of the use condition information 322 for each medium type described in the export license 320 illustrated in FIG. 11 or for each export I/F to the external devices.

A digital rights protection flag 331 is information for specifying whether to digital rights-protect content to be exported. In the case of digital rights-protecting export content, the main unit viewing period matching flag 151 is information for matching the viewing period in a medium as an export destination with the viewing period of a main unit playback. Export destination viewing period information 333 is information for specifying the viewing period for each medium in the case where the viewing period in a medium as an export destination is not matched with the viewing period of the main unit playback. A transcode flag 334 is information for representing whether a transcode conversion such as codec conversion may be performed during the export.

In the present embodiment, the export license information 473 of the license metadata 470 has the number of exportable times 145. The receiver 50 acquires the export license 320 as much as the above-described number of times from the DRM server 64. However, as another modification example, the export license information 473 of the license metadata 470 has not the number of exportable times 145. Instead, the export license 320 has information on the number of exportable times. There is possible an example where the specified number of exportable times can be exported by using one license.

Screen configuration examples of FIGS. 12 to 16, 18, and 19 according to the second embodiment are illustrated in the same manner as in the first embodiment.

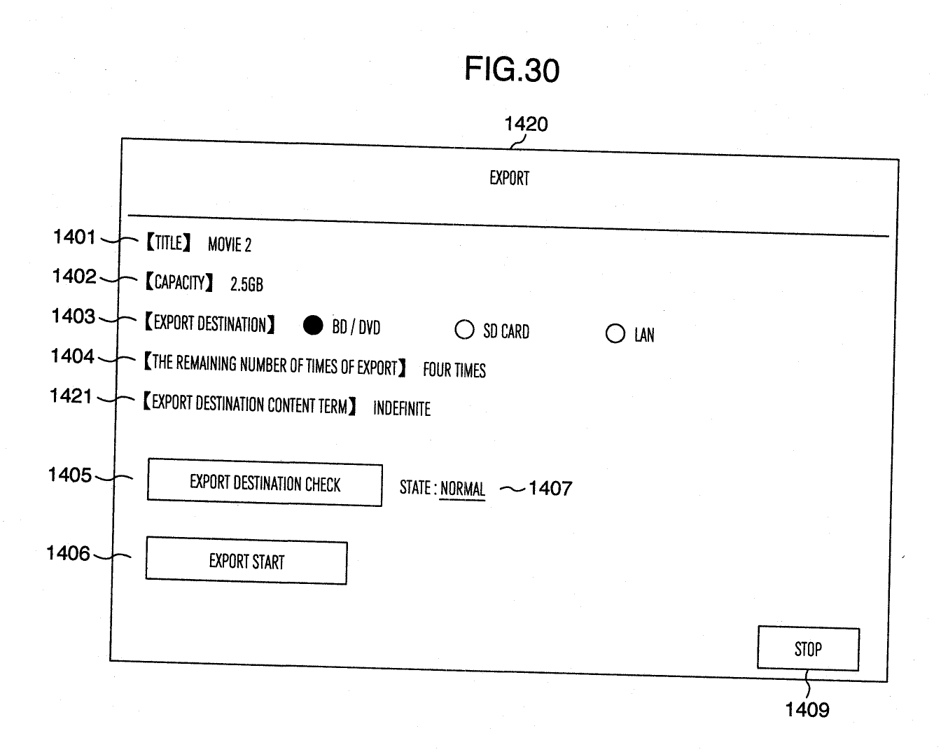

In the case of the second embodiment, the export screen of FIG. 17 according to the first embodiment is displayed as in a field 1420 of FIG. 30.

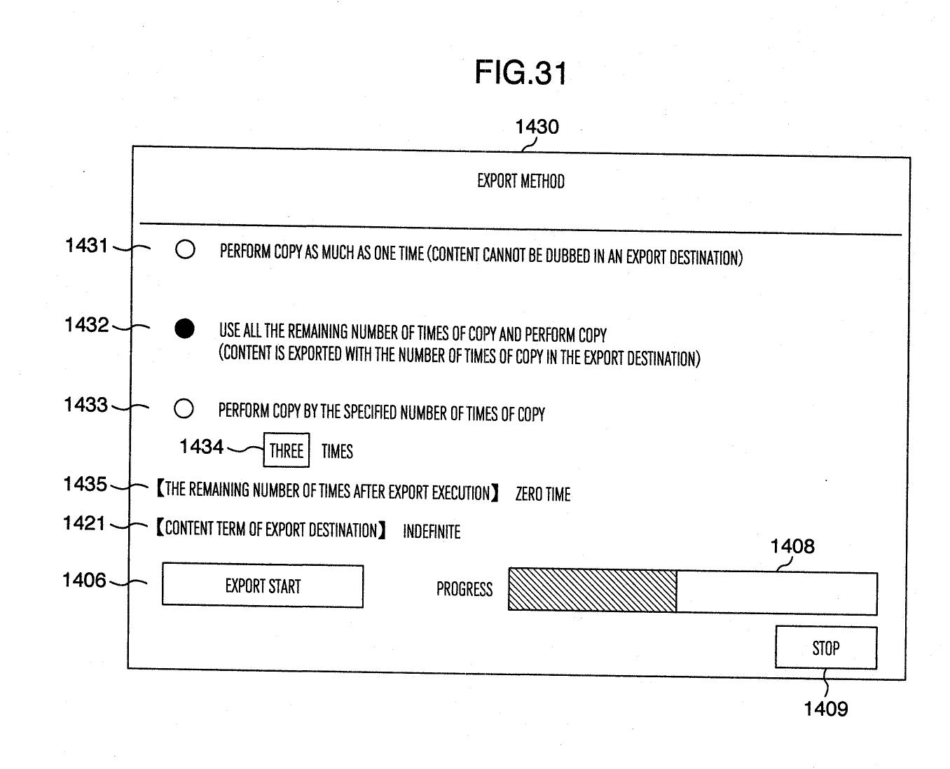

The second embodiment differs from the first embodiment in the following points. That is, in addition to the remaining number of times of export 1404, the export destination content term 1421 is presented based on the description content of the license metadata 470. In addition, after the export start button 1406 is selected, the export is not immediately executed and the screen transits to the export method selection screen 1430 of FIG. 31.

On the export method selection screen 1430, an option of a copy method is presented. Three types of an execution 1431 of a copy for one time, an execution 1432 of a copy by using all of the remaining number of times of copy, and an execution 1433 of a copy by using the specified number of times of copy can be selected.

In the case of selecting the copy execution 1431, the remaining number of times of export 1404 is reduced by one. The content 75 is dubbed to the removable medium or the network connection device. Further, as the export conditions of an export destination, the content 75 is set to no more copy state.

In the case of selecting the copy execution 1432, a value X of the remaining number of times of export 1404 is changed into zero. The content 75 is dubbed to the removable medium or network connection device. Further, as the export conditions of an export destination, the number of times of copy of the content 75 is set to X−1 times.

In the receiver 50, the number of times of copy is managed by using a number X of the export license 500. The export of X times can be executed to the removable medium in no more copy state. In the removable medium, a number capable of duplicating content is managed as the number of times of copy in addition to the recorded content 75 entity. Therefore, when executing export to the removable medium, a value resulting from subtracting one from X is set as the number of times of copy of the removable medium.

In the case of selecting the copy execution 1433, the number of times of copy is supplied in an entry field 1434 by a value P, and the number of times of the value P is used. A value X of the remaining number of times of export 1434 is changed into X−P times, and the content 75 is dubbed to the removable medium or network connection device. As the export conditions of an export destination, the number of times of copy of the content 75 is set as P−1 times.

The remaining number of exportable times after the export execution at the time of selecting the copy executions 1432 and 1433 is reflected on the copy execution 1435.

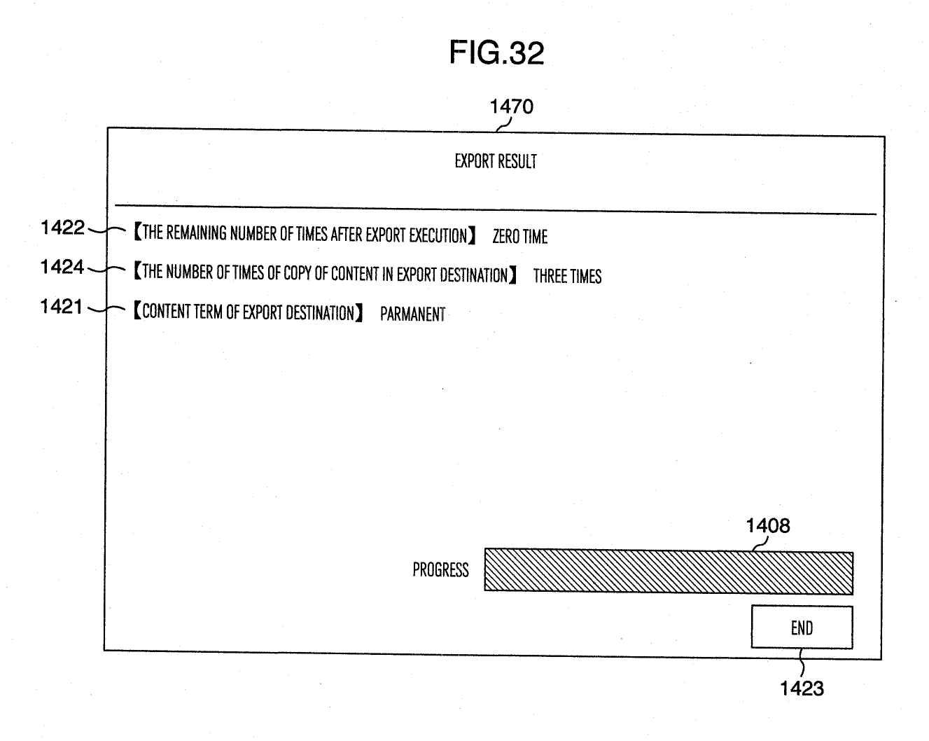

When the export method is selected and the export start button 1406 is selected, the export is started. The progress is displayed on the field 1408, and when a stop button 1409 is selected, the export can be stopped before start or on the way. When the export is completed, the screen transits to an export result display screen 1470 of FIG. 32.

On the export result display screen 1470, information on the remaining number of times of export (zero time in the case of this example) (1422), on the number of times of copy of content in the export destination (three times in the case of this example) (1424), and on a content term of the export destination (1421) is presented to a user.

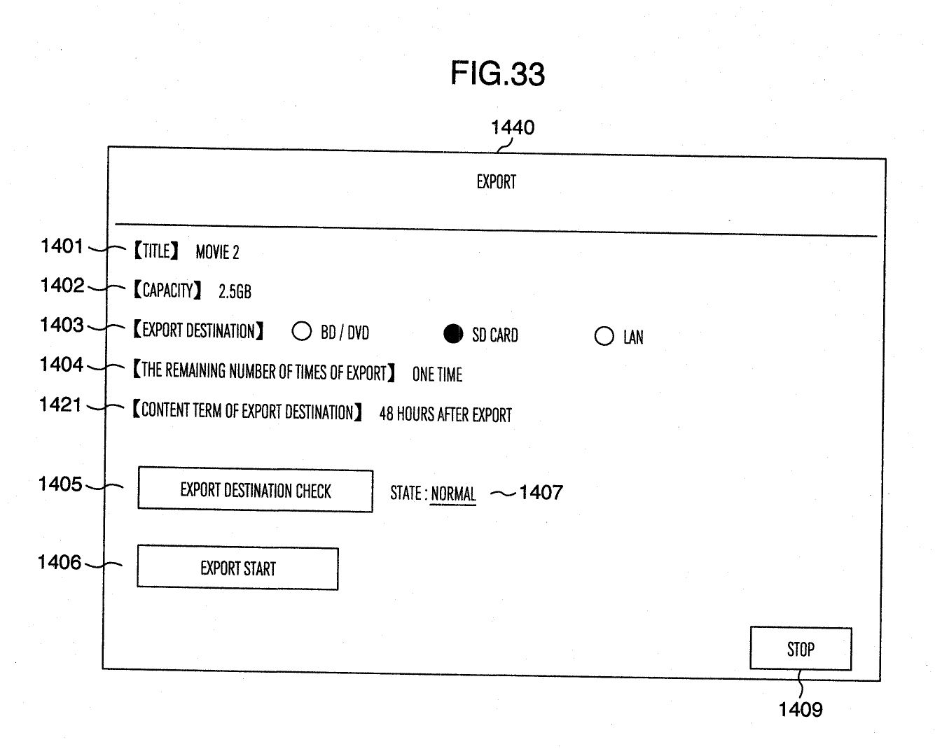

FIG. 33 illustrates another example of an export screen, the remaining number of times of export 1404 is presented to be one time based on the description in the license metadata 470. Further, the export destination content term 1421 is not indefinite and the term is presented as in “48 hours after the export”.

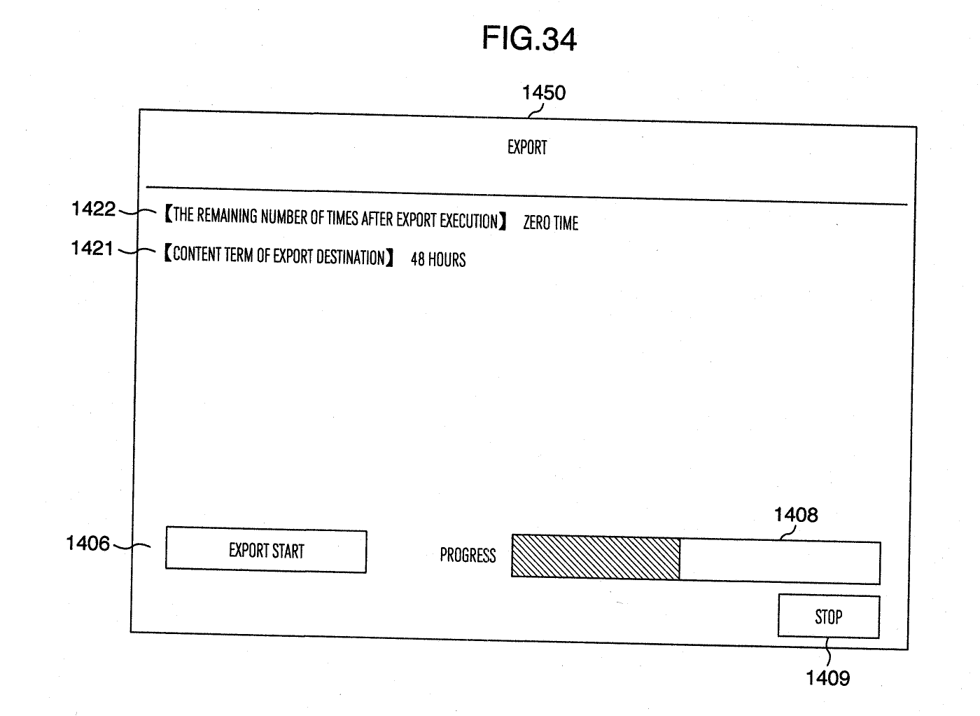

In this case, when the export start button 1406 is selected, the screen transits to the export execution screen 1450 as in FIG. 34.

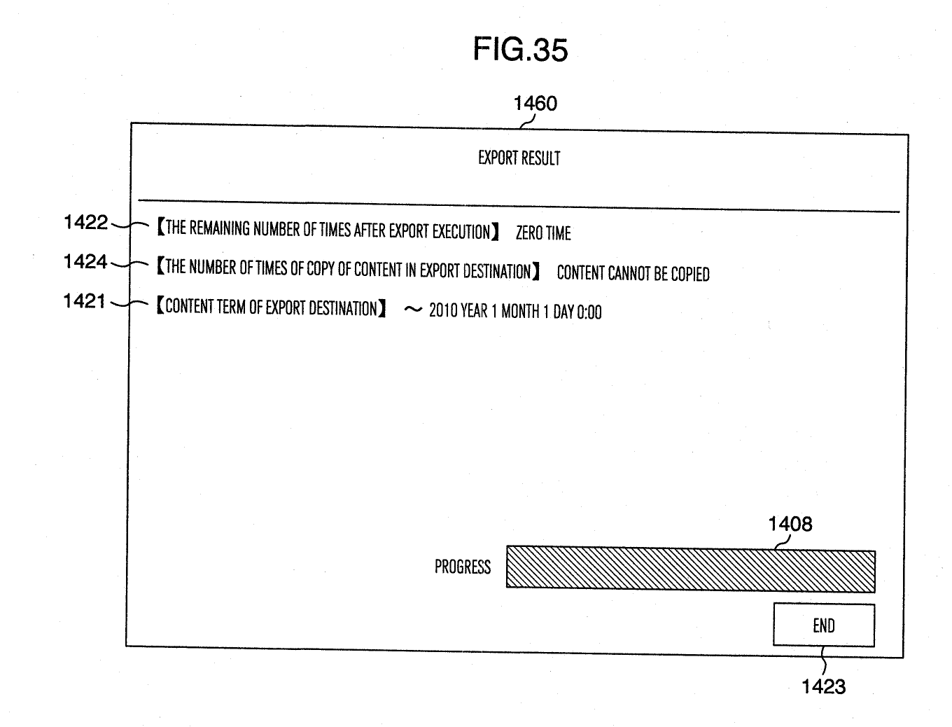

Here, the remaining number of times 1404 after the export execution is presented, and when the export start button 1406 is selected, the export is executed and the progress is displayed as in the field 1408. When the export is completed, the screen transits to the export result display screen 1460 as in FIG. 35. Here, when the content term 1421 of the export destination is determined as an absolute value, the term is presented.

For example, when the term described in the export license 320 is a relative time after the export, the use end term is determined as the absolute time during the export completion. When the term described in the export license 320 is an absolute start date and time and end date and time from the start, the date and time as an absolute term can be presented from the start of an export screen.

In the same manner as in FIG. 32, information on the remaining number of times of export (zero time in the case of this example) (1422) and on the number of times of copy of content in the export destination (the copy is not enabled in the case of this example) (1424) also is presented to the user.

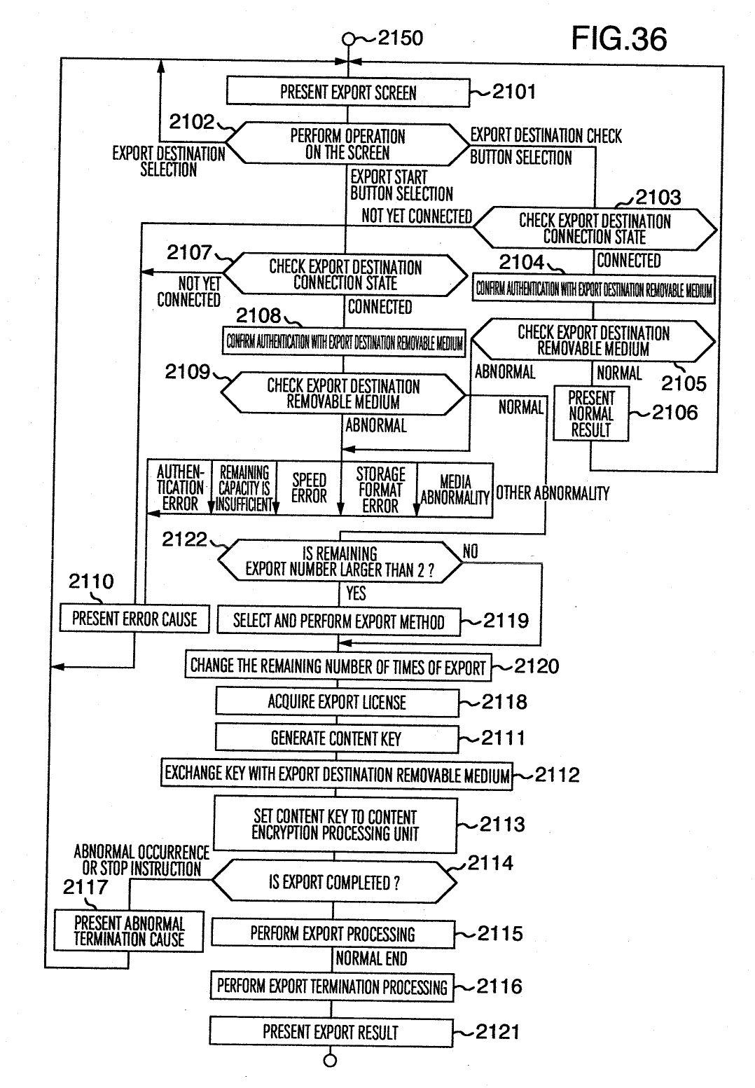

FIG. 36 illustrates a process flow 2150 of the stream export processing unit 57 which realizes the above-described screen presentation example. The process flow 2150 differs from the process flow 2100 of the first embodiment in the following points.

That is, after the check of the export destination medium (2109), the stream export processing unit 57 checks whether the remaining number of times of export is two or more times (2122). If YES, the export with the number of times of copy can be executed. Therefore, the stream export processing unit 57 selects and operates the export method, and instructs the export execution (2119). If the remaining number of times of export is one time, the export with the number of times of copy cannot be executed in the export destination. Therefore, the selection screen of the export method is not presented and the export is executed. When the export is instructed, the number of times used in the export is reduced and the remaining number of times of the export is changed according to the selection method (2120). After the export termination processing (2116), a step of presenting export results (the remaining number of times of the export and the content term of the export destination) to the user (2121) is added.

In the above-described example, the export to the removable medium is described. When the export to the network connection device is executed, the network connection device 570 as an export destination is checked (2209) at step 2200 of a flowchart in FIG. 24. Then, in the same manner as in the above-described example, there are added steps of checking the remaining number of times of the export (2122), selecting and operating the export method (2119), reducing the number of times used in the export, and changing the remaining number of times of the export (2120) according to the selection method. Further, after the export termination processing (2116), a step of presenting export results (the remaining number of times of the export and the content term of an export destination) to the user (2121) is added.

The above steps permit the content receiving apparatus to realize an export having the number of times of copy to which the number of times of copy specified by the user is given, and an export having a use term with respect to a removable medium and a network connection device when exporting content necessary for a digital rights protection,

Further, when executing export having the number of times of copy, the content receiving apparatus can clearly specify the number of times of copy of content in an export destination as a result of the export. Further, when executing the export having the use term, in the case where the use term of content is determined as an absolute value, the content receiving apparatus can clearly specify the term after the execution.

In addition, the present invention is not limited to the above-described embodiments and includes various modification examples. For example, the above-described embodiments have been described in detail for intelligibly describing the present invention and not necessarily limited to an apparatus including all the described structures. A part of structures according to an embodiment can be substituted for a structure according to another embodiment, and further, a structure according to another embodiment can be added to a structure according to an embodiment. Further, addition, deletion or substitution of another structure can be performed to a part of structures according to each embodiment.

All or part of the configurations, functions, processing units, and processing methods described above may be implemented by hardware by designing them, for example, by integrated circuits. The configurations and the functions described above may also be implemented by software by the processor interpreting and executing the programs which implement the functions. When a function is executed, the information such as the corresponding program, tables, and files may be stored in a storage device such as a memory, a hard disk, or a solid state drive (SSD). When a function is not executed, the information such as the program, tables, and files may be stored in a storage medium such as an IC card, an SD card, or a DVD.

Note that only control lines and information lines considered to be necessary for the description are shown but that not all control lines or information lines of the product are shown. It should be considered that all configurations are actually connected each other.

It should be further understood by those skilled in the art that although the foregoing description has been made on embodiments of the invention, the invention is not limited thereto and various changes and modifications may be made without departing from the spirit of the invention and the scope of the appended claims.

1. A content receiving apparatus comprising:
a receiving unit which is an export medium having a content recording unit which records content and an export condition information recording unit which records export condition information of content, and configured to receive specification of an export medium which exports content;
an export condition information acquisition unit having information on the number of times of export indicating the number of times of export of content to be exported to an export medium specified by the receiving unit, and configured to acquire export condition information in which export conditions of the content are described; and
an export unit configured to export the content to the export medium in which the receiving unit receives specification, acquire the information on the number of times of export from the export condition information for the content, and in the case where the number of times of export of the acquired export information is two or more times, export the content to the recording medium, and set the export condition information of the content to the export condition information recording unit in the recording medium by using the number of times of export as much as multiple times.

2. The content receiving apparatus according to claim 1,
wherein after completion of an export to the recording medium by using the number of times of export of multiple times, the export unit presents information on the number of times of export of the export medium to a user.

3. A content receiving apparatus comprising:
a receiving unit configured to receive specification of an export medium which exports content;
an export condition information acquisition unit configured to acquire export condition information describing export conditions of content to an export medium specified by the receiving unit; and
an export unit configured to export the content to the specified export medium,
wherein:
the export medium has a content recording unit and an export condition information recording unit of content, and
the export condition information has use term information indicating a use term in the export medium of the content; and
the export unit acquires the use term information from the export condition information for the content, exports the content to the recording medium, and sets the export condition information of the content to the export condition information recording unit in the recording medium.

4. The content receiving apparatus according to claim 3,
wherein after completion of an export to the recording medium, in the case of determining a use term of the recording medium based on the use term information, the export unit presents the determined use term information to a user.
